(19) United States
(12) Patent Application Publication
(10) Pub. No.: US 2009/0033648 A1
(43) Pub. Date: Feb. 5, 2009

(54) Light film device

(76) Inventors: George Podd, Lake Forest, IL (US); Russell Schweizer, Village of Lakewood, IL (US); Timothy Copeland, Chicago, IL (US)

Correspondence Address: Douglas H. Pauley;Pauley Petersen & Erickson, Suite 365, 2800 West Higgins Road, Hoffman Estates, IL, 60195, US

(21) Appl. No.: 11/444,174

(22) Filed: May 31, 2006

Related U.S. Application Data
(63) Continuation-in-part of application No. 11/259,909, filed on Oct. 27, 2005.
(60) Provisional application No. 60/623,754, filed on Oct. 29, 2004.
(60) Provisional application No. 60/724,476, filed on Oct. 7, 2005.

(30) Foreign Application Priority Data
Oct. 28, 2005 (TW) 94138165
Oct. 28, 2005 (US) PCT/US05/39141

(51) Int. Cl. G06F 3/038

(52) U.S. Cl. 345/211

(57) ABSTRACT

A light film apparatus having an illuminated graphics panel with at least two segments that can be individually powered. A controller manages a power which is delivered from a power supply to each of the segments, so that each of the segments is either powered on, powered off or powered to an intermediate level. With the independent control of power to the different segments, it is possible to create a three-dimensional appearance of a moving image from a generally two-dimensional panel arrangement.

### BACKGROUND OF THE INVENTION

1. Field of the Invention

This invention relates generally to a light film device, particularly an illuminated graphics panel that can be positioned on or near a window or glass surface, such as on a vehicle.

2. Discussion of Related Art

Electroluminescent lamps or devices have been used for signage. There are known methods for manufacturing EL lamps or devices.

One conventional emergency exit sign uses an EL lamp in combination with a pilot light which is connected to the EL lamp by way of a photoelectric link. The photoelectric link monitors the brightness of the EL lamp and keeps on the pilot light as long as the EL lamp is lit. Illumination provided by the EL lamp may be less than the illumination of background brightness, making it difficult to tell by looking at the EL lamp whether or not the EL lamp is energized. Thus, the pilot light provides a point of illumination that can be easier to detect than whether the EL lamp is lit. This particular combination can be useful for building inspectors that check the operational status of an exit sign.

### SUMMARY OF THE INVENTION

There is a need to enhance visibility of graphic elements in different places, for many safety reasons and marketable applications. For example, enhanced visibility of graphic elements on vehicles may help overcome low visibility driving conditions, such as snow, rain, darkness and/or fog. With increased visibility of specific graphic elements on a vehicle, other motorists can better see dedicated information, particularly in adverse weather conditions or low visibility driving conditions. The light film device of this invention can be used in any suitable or desirable situation or format, such as a safety signal, a public service symbol including symbols of the Department of Transportation, the Military, the National Guard, the Police and the Fire Departments, a construction sign, a zone authority, a help/warning message, and many other marketable applications, including zone parking passes for major events, promotional icons, vehicle brand logos and advertising messages.

There is also a need for a product according to this invention, to address and satisfy specific criteria for practical or real world use. In one embodiment of this invention, this is achieved by integrating illuminated graphic panels with sensors, a dim switch or sensor and a control module, which can be programmed and/or assembled to operate within specific parameters of a dedicated driving or usage environment.

A light film device according to embodiments of this invention can include an electroluminescent (EL) panel integrated or combined with a translucent graphics panel, a light sensor, a motion sensor, a time sensor and/or dim settings. The light film device can be mounted to a structure or surface, such as a vehicle window or a building window, to allow theme graphics, such as words, logos and/or symbols, to be highly visible, for example during low visibility weather and/or driving conditions.

There is a need to provide specific operating criteria, in certain situations. Issues should be addressed for real world or marketplace product applications.

In other embodiments according to this invention, the light film device can be used to display the appearance of a moving image. For example, a light film device of this invention can be used to display a dynamic or moving flag, to give the appearance that the flag is blowing in the wind. The creation or animation of a moving image can be accomplished with an EL panel having two or more segments that are positioned adjacent with respect to each other. A controller can be used to vary power delivered to each segment. For example, each segment can be individually controlled to dim, brighten, pulse off and on, switch off and/or switch on, for different desired effects.

In some instances, product according to this invention, when introduced into the marketplace, should conform to local regulations, such as a variety of U.S. Federal and U.S. State transportation regulations regarding lumen output levels, animation effects and product positioning or placement on a vehicle. A dim switch or control feature may allow a lumen output level to be adjusted to within or to not exceed one or more set regulations. This feature or adjustment can occur manually or automatically. A mode switch feature can ensure that a final use falls within or meets regulations. The product configuration may allow mounting on a side window or a back window of a vehicle, for example, depending on an intended use.

A product of this invention may be easy to use, require low maintenance and operate within control module settings and functional parameters. For example, a motion sensor, a light sensor and/or a timer switch can be used to make all necessary or desired adjustments, so that the user does not have to use or address the on/off switch once a desired operational mode is set. The user may have an option to change a mode setting. A battery recharge capability, particularly if automatic, allows the user to not be concerned with replacing or manually recharging batteries. A removable battery module provides a simple battery replacement operation. A flexible mounting adaptation and a DC adaptor with a control module allows easy installation. A battery pack does not require auto wiring operation for easier installation.

A product according to this invention can be manufactured and operate within a range of reasonable costs, based on potential market applications. An interchangeable translucent graphic panel and layer assembly allows the EL component to be standardized as white backlight. Thus, custom printing of clear plastic sheet material minimizes the cost, the inventory and the production time. Sensors optimize product function, provide a user-friendly product and prolong battery life during use. There can be a battery recharge capability with, for example a solar panel option, to prolong battery life. A vehicle DC port and adapter/control module allows use of the device without batteries.

With a product according to this invention, consumers may obtain value added attributes of increased visibility for their specific needs. Also, the consumer is able to use the light film device of this invention, if necessary within legal vehicle guidelines, and benefit from improved user features and cost effective operation. The light film device of this invention can include a static or constant display or illumination and/or a dynamic or animated graphic display or illumination, and can also include two or more graphics panels. The light film device of this invention can be used for any suitable application other than vehicular applications, such as for signage in a home window or in a business or store-front window.

### BRIEF DESCRIPTION OF THE DRAWINGS

Features of this invention can be better understood when this specification is read in view of the drawings, wherein:

FIG. 1 is a perspective front view of a light film device having a graphic display area and a light sensor location, according to one embodiment of this invention;

FIG. 2 is a perspective rear view of the light film device as shown in FIG. 1, including solar panels and a removable battery module;

FIG. 3 is an exploded perspective rear view of a light film device, according to one embodiment of this invention;

FIG. 4 is a rear view of the light film device, as shown in FIG. 3;

FIG. 5 is a top view of the light film device, as shown in FIG. 3;

FIG. 6 is a bottom view of the light film device, as shown in FIG. 3;

FIG. 7 is a side view of the light film device, as shown in FIG. 3;

FIG. 8 is a front view of a light film device, according to another embodiment of this invention;

FIG. 9 is a rear view of the light film device, as shown in FIG. 8;

FIG. 10 is a side view of the light film device, as shown in FIG. 8;

FIG. 11 is a front view of a light film device, according to another embodiment of this invention;

FIG. 12 is a rear view of the light film device, as shown in FIG. 11, operatively connected to a solar panel;

FIG. 13 is a side view of the light film device, as shown in FIG. 11;

FIG. 14 is a sectional view of the light film device of FIG. 4, taken along section line A-A shown in FIG. 4;

FIG. 15 is a sectional view of the light film device of FIG. 4, taken along section line B-B shown in FIG. 4;

FIG. 16 is a sectional view of the light film device of FIG. 4, taken along section line C-C shown in FIG. 4;

FIG. 17 is a perspective view of a light film device mounted to a vehicle window, according to one embodiment of this invention;

FIG. 18 is a perspective view of a light film device, including a battery pack and a solar panel, according to another embodiment of this invention;

FIG. 19 is a perspective view of a light film device, showing two versions of an adapter plug, according to another embodiment of this invention;

FIG. 20 is a front view of a light film device, according to another embodiment of this invention;

FIG. 21 is a rear view of the light film device, as shown in FIG. 20;

FIG. 22 is a front view of a solar panel, according to one embodiment of this invention;

FIG. 23 is a side view of the solar panel, as shown in FIG. 22;

FIG. 24 is a rear view of the solar panel, as shown in FIG. 22;

FIG. 25 is a flow chart showing program steps of light and motion control, according to one embodiment of this invention;

FIG. 26 is a flow chart showing program steps for light, motion and wireless control, according to one embodiment of this invention;

FIG. 27 is a flow chart showing program steps for light, motion and sound control, according to one embodiment of this invention;

FIG. 28 is a flow chart showing program steps for light and acceleration control, according to one embodiment of this invention;

FIG. 29 is a flow chart showing program steps for light and dual acceleration control, according to one embodiment of this invention;

FIG. 30 is an exploded view of an outer layer or graphics panel positioned above an EL panel having a plurality of segments, according to one embodiment of this invention;

FIG. 31 is a series view showing how the individual segments of FIG. 30 can be illuminated differently to produce the appearance or effect of a waving flag;

FIG. 32 shows several different silhouette views of different shapes, such as flag or banner shapes, according to different embodiments of this invention;

FIG. 33 shows schematic views of panel layouts with differently configured segments, according to different embodiments of this invention;

FIG. 34 is a series of diagrams illustrating how an EL panel having three segments can be powered between an on mode and an off mode, over a given time period, according to one embodiment of this invention;

FIG. 35 is a series of diagrams illustrating how an EL panel having three segments can be powered between an off mode, an on mode and an intermediate power level, to have a variable illumination or intensity, according to another embodiment of this invention;

FIG. 36 is a series view showing an EL panel, to the left in an off mode and to the right in an on mode, according to one embodiment of this invention;

FIG. 37 is a series view showing an EL panel, to the left in an off mode and to the right in an on mode, according to another embodiment of this invention;

FIG. 38-41 each shows a series of two diagrams illustrating an EL panel with a particular segment layout, on the left side, and the corresponding outer layer positioned over the EL panel, on the right side, according to different embodiments of this invention;

FIG. 42 is a plan schematic view showing a layout of different segments forming an EL element, according to one embodiment of this invention;

FIG. 43 is an exploded perspective view of an EL panel, according to one embodiment of this invention;

FIG. 44 is a partial cross-sectional view of the EL panel, as shown in FIG. 43;

FIG. 45 is an exploded perspective view of an EL panel, according to another embodiment of this invention;

FIG. 46 is a partial cross-sectional view of the EL panel, as shown in FIG. 45;

FIG. 47 is an exploded perspective view of an EL panel, according to another embodiment of this invention;

FIG. 48 is a partial cross-sectional view of the EL panel, as shown in FIG. 47;

FIG. 49 is an exploded perspective view of an EL panel, according to another embodiment of this invention; and

FIG. 50 is a partial cross-sectional view of the EL panel, as shown in FIG. 49.

### DESCRIPTION OF THE INVENTION

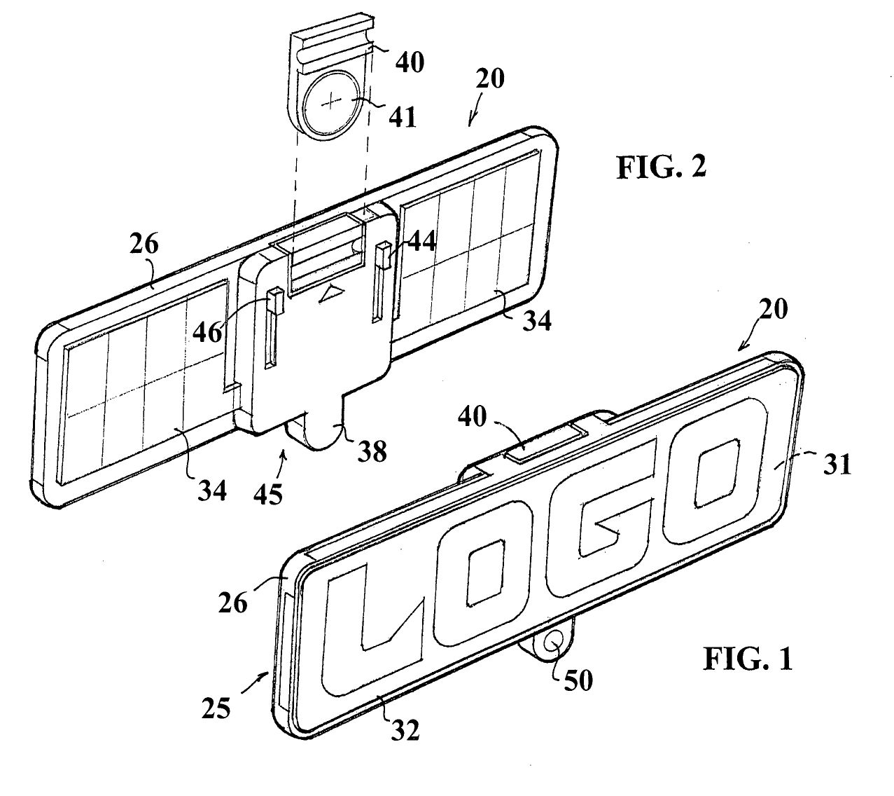

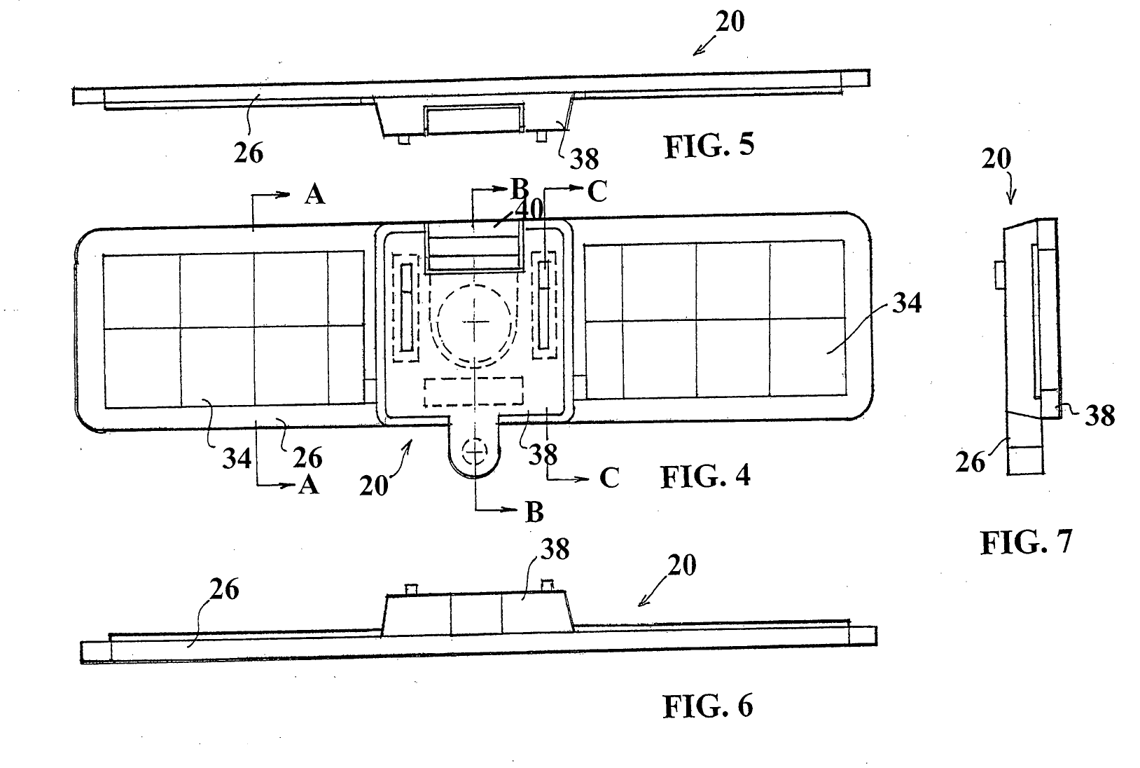

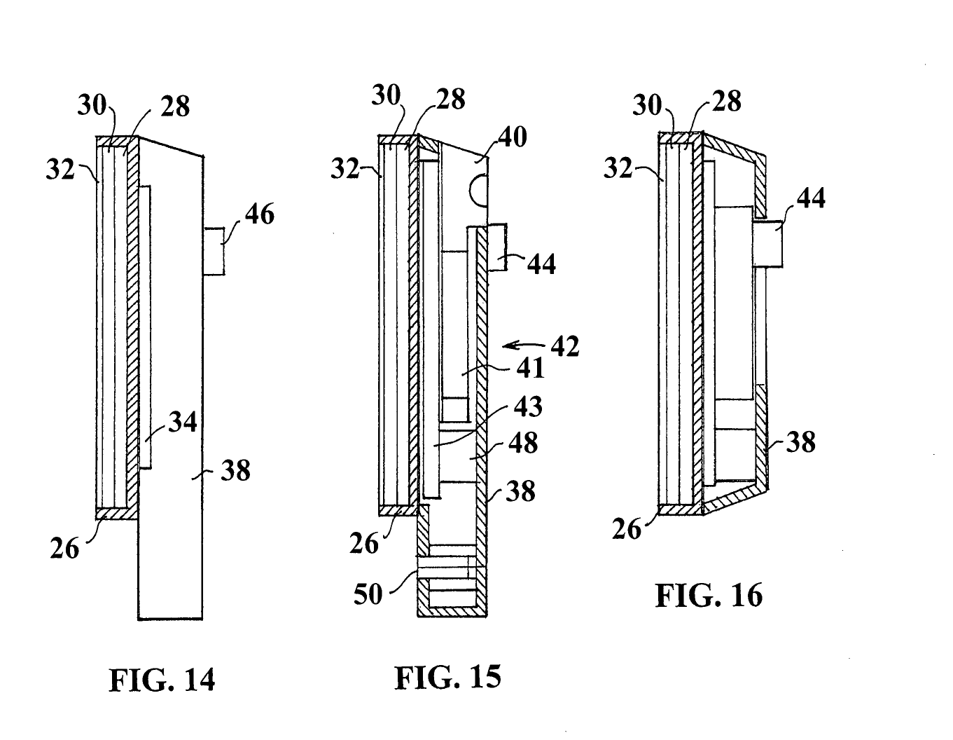

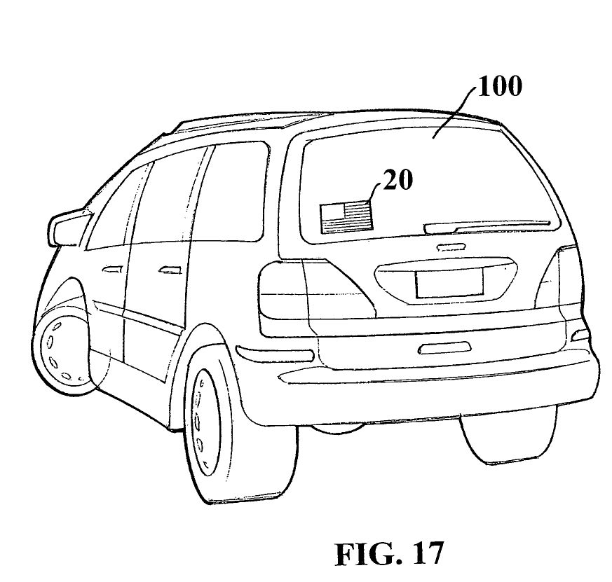

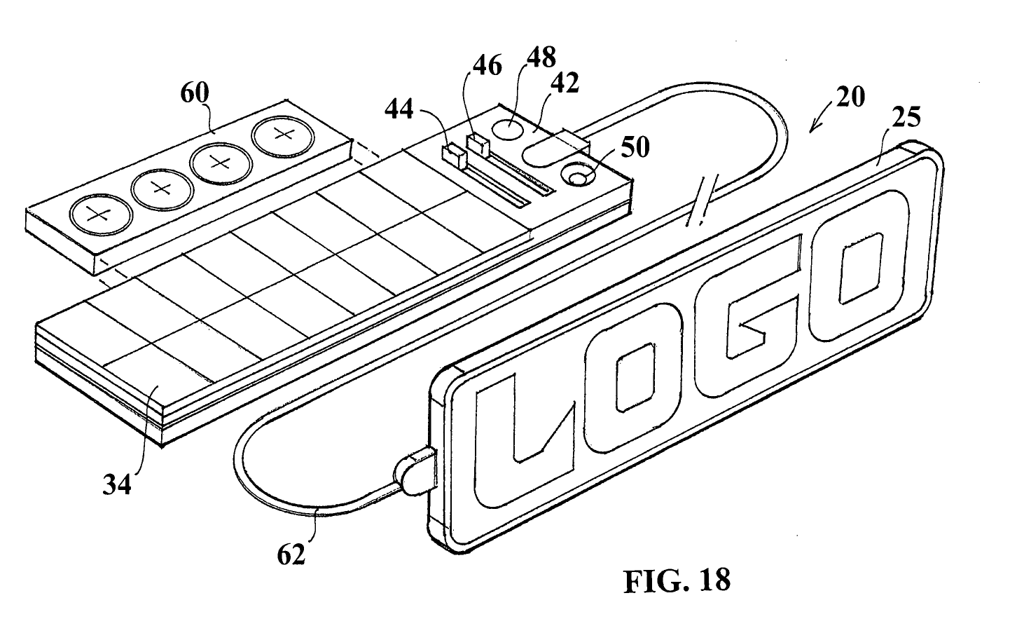

This invention provides a light film device including a light film component, a control module and in certain embodiments a solar power unit and/or a battery. FIGS. 1-19 show a light film device, according to certain embodiments of this invention. The light film device can be mounted with respect to a window, such as vehicle window 100 shown in FIG. 17, to display desired graphics for marketing applications, safety applications and/or emergency situations, for example. The light film device of this invention can provide highly visible graphics that other motorists and/or pedestrians or bystanders will be able to see in adverse weather conditions and/or adverse driving conditions, for example. The light film device of this invention can be used for a variety of applications including, but not limited to, safety signals, public service symbols, such as the Department of Transportation, the Military, the National Guard, the Police and the Fire Department logos or plaques, construction locations and workers, zone authorities, help/warning messages, and other suitable informational and/or marketable applications, such as zone parking passes for major events, promotional icons, vehicle brand logos, animated images, dynamic images, and advertising messages.

Throughout this specification and in the claims, the phrase illuminated graphics panel, the phrase electroluminescent display device, the phrase electroluminescent display, the phrase electroluminescent device and the phrase electroluminescent element, the phrase light emitting diode (LED), as well as other similar phrases, are intended to be interchangeable with each other. The phrase illuminated graphics panel or any of the other interchangeable phrases each is intended to relate to a lighting device that includes panel shaped elements or segments which can be lit by any suitable light supply or source. The phrase illuminated graphics panel and the interchangeable phrases are also intended to relate to and include currently available EL lighting devices, as well as EL devices or other suitable lighting devices that may become available.

In certain embodiments of this invention, the illuminated graphics panel may be designed and/or manufactured with light emitting diode (LED) technology, which can provide cost savings. For example, it may be possible to diffuse LED lights into dedicated panel segments, which can have any suitable dimensions, cross section and or/or shape.

In one embodiment of this invention, a pocket approach or arrangement can use molded plastic opaque walls, when viewed from a top direction to see a shape of particular artwork segments that can partition off LED lighted segments, such as with walls or structural baffles. An LED structure can be mounted on or to a board, such as wired, soldered or otherwise electrically connected to a PC board, and positioned near, for example beneath each segment. The LED structure can be pressed into a pocketed light diffuser, for example a clear etched plastic, in a desired shape of the segment.

In another embodiment according to this invention, to accomplish an evenly distributed lighting, segments of the wall structure can be molded into different shapes, such as art shapes. The segment shapes can be injection molded plastic, for example, with or without etching to provide a textured outer surface which can but need not be back painted with a white or non-white paint or other similar material. LED structures can be mounted or positioned adjacent or near an edge of the segment, to distribute light into the segment. Edge lighting can help implement different intricate or complex graphic designs.

When the illuminated graphics panel of this invention is constructed with LED structures, the overall dimensions will typically be greater than a similar product manufactured with one or more EL elements 28. The LED structure requires increased segment material to more evenly distribute light for each graphic segment, which can result in added thickness of the panel to achieve better light distribution, depending upon the particular use. However, if costs associated with the LED technology are or become low enough, there can be a significant market demand for the LED technology.

In one embodiment of this invention, such as shown in FIGS. 1-7, light film device 20 comprises light film component 25. Light film component 25 comprises frame or housing 26 for mounting or containing housing elements of light film component 25. Housing 26 can have any suitable shape and/or size to properly house one or more elements of light film component 25. An electroluminescent (EL) element 28, a translucent element 30 and an adhesion element 32 are positioned, arranged or configured in a layered, sandwiched or surface-to-surface relationship and are securely housed within and/or connected to housing 26, according to embodiments similar to that as shown in FIGS. 1-3. Preferably but not necessarily, each element surface or another suitable portion of each element is positioned with respect to a surface or another suitable portion of an adjacent element of light film component 25. For example, elements of light film component 25 can be in surface-to-surface contact with adjacent or nearby elements of light film component 25. An interchangeable panel, such as a tinted translucent panel, can be positioned to mount between EL element 28 and the surface to which housing 26 is mounted, such as window 100. An interchangeable translucent graphic panel having a layered assembly allows EL element 28 to be standardized, for example as white backlight, and thus custom printing on clear plastic sheet material can be used to reduce costs, inventory and/or production time.

In certain embodiments of this invention, the elements of light film device 20 can have any suitable overall and/or cross-sectional shape and/or can be configured in any suitable relationship. It is possible to provide a layered configuration wherein each element layer is laminated, such as during manufacture or construction, to preferably but not necessarily produce an apparatus or device having a relatively slim design. It is also possible to provide a backer plate configuration, wherein elements are integrated with, affixed to and/or connected to a backer plate, such as an injection molded backer plate. It is also possible to provide a backer housing configuration, wherein elements are integrated with, affixed to and/or connected to a module, such as an injection molded module. In each configuration, subassemblies can be mounted at any suitable location to dedicated or available surfaces, including any suitable vehicle surface.

EL element 28 of this invention may comprise any suitable conventional EL element available in the marketplace. In one embodiment of this invention, EL element 28 comprises at least one panel. For example, EL element 28 may include at least one white color or non-color panel that extends along at least a portion of a front surface or area of housing 26. EL element 28 can comprise other color panels in addition to or in lieu of the at least one white color or non-color panel, any of which is suitable to back light graphics panel 31. Preferably but not necessarily, EL element 28 covers all or substantially an entire area of the front surface or area of housing 26. In certain embodiments of this invention, EL element 28 can be produced or printed with any suitable graphic, which may eliminate the need for element 30.

In certain embodiments of this invention, EL element 28 can have a plurality of segments, each of which can be individually controlled. Control module 42 can emit an output signal to any one or more of the different segments of the EL element 28. With the independent control of each segment, many different complex static or dynamic graphics can be displayed with light film device 20 of this invention.

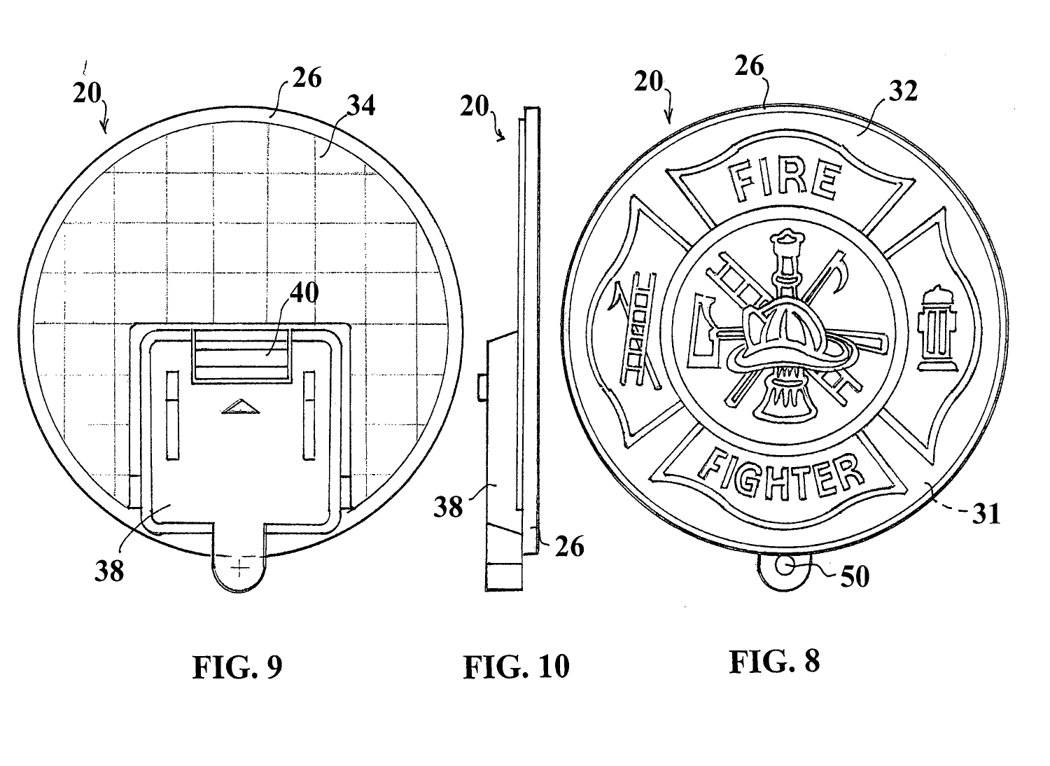

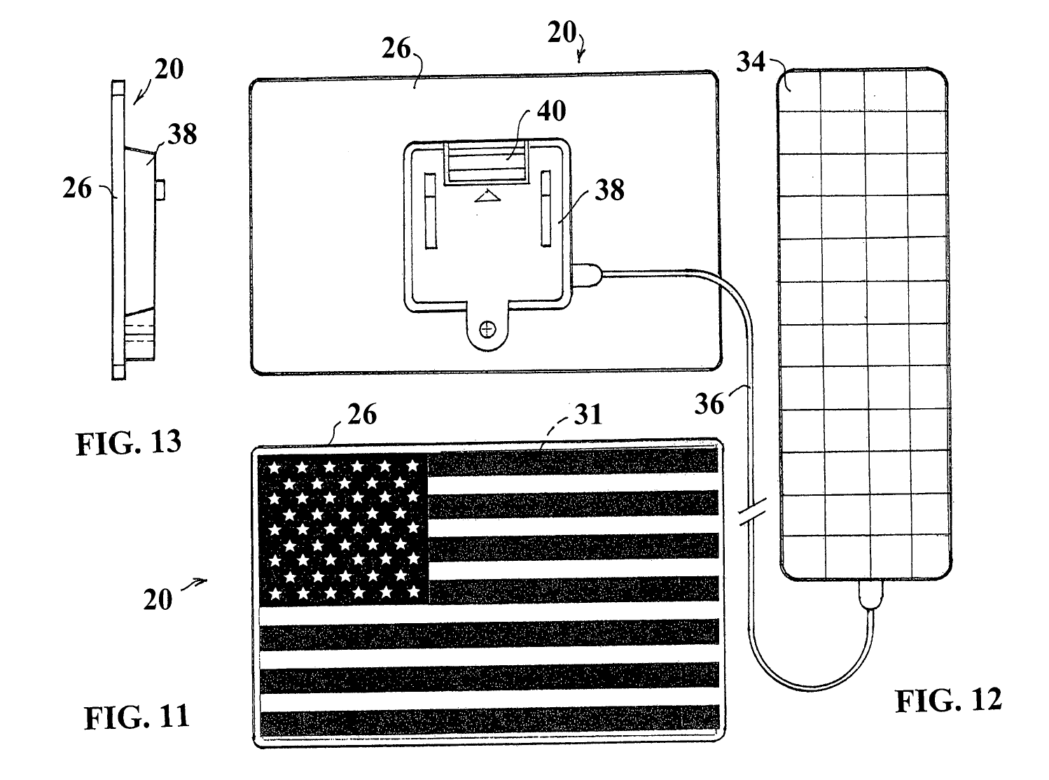

As shown in FIG. 3, element 30 may or may not be translucent and is positioned in a relatively fixed relationship with respect to EL element 28. For example, a first surface of element 30 preferably contacts an adjacent surface of EL element 28. Element 30 may comprise a suitable or desirable graphics panel 31, such as shown in FIGS. 1 and 8. Graphics panel 31 can include any desirable graphic, such as a logo as shown in FIG. 1, a fire department plaque as shown in FIG. 8 or an American flag as shown in FIG. 11, for example. Those skilled in the art will understand that element 30 can include graphics panel 31 having any desirable or suitable dimensions, cross section and/or shape. Graphics panel 31 can have any desirable number and/or configuration of graphic displays. Element 30 and/or graphics panel 31 can include any suitable film material, such as an acetate film layer, a LEXAN film layer or any other suitable clear sheet material. Preferably but not necessarily, element 30 and/or graphics panel 31 each is printed with a translucent ink, such as CMYK ink or a spot color inks.

Adhesion element 32 comprises one surface that contacts another surface of element 30, for example as suggested by FIG. 3. Adhesion element 32 includes a surface that contacts a support or mounting surface, such as a business front window, a door window or a vehicle window. Adhesion element 32 can be of any suitable clear or translucent adhesive, such as in a layer form. Adhesion element 32 may include a suitable adhesive component or layer to removably secure light film device 20 to the mounting surface so that light film device 20 is securely mounted to the mounting surface when in use, but can be selectively removed from the mounting surface without damage to adhesion element 32 and/or the mounting surface. Other suitable components, such as suction cups, brackets, other adhesives, static cling devices, screws, wire, hook-and-loop fasteners and/or any other mechanical, electrical and/or magnetic connector can be used to mount light film device 20 with respect to a mounting structure or surface.

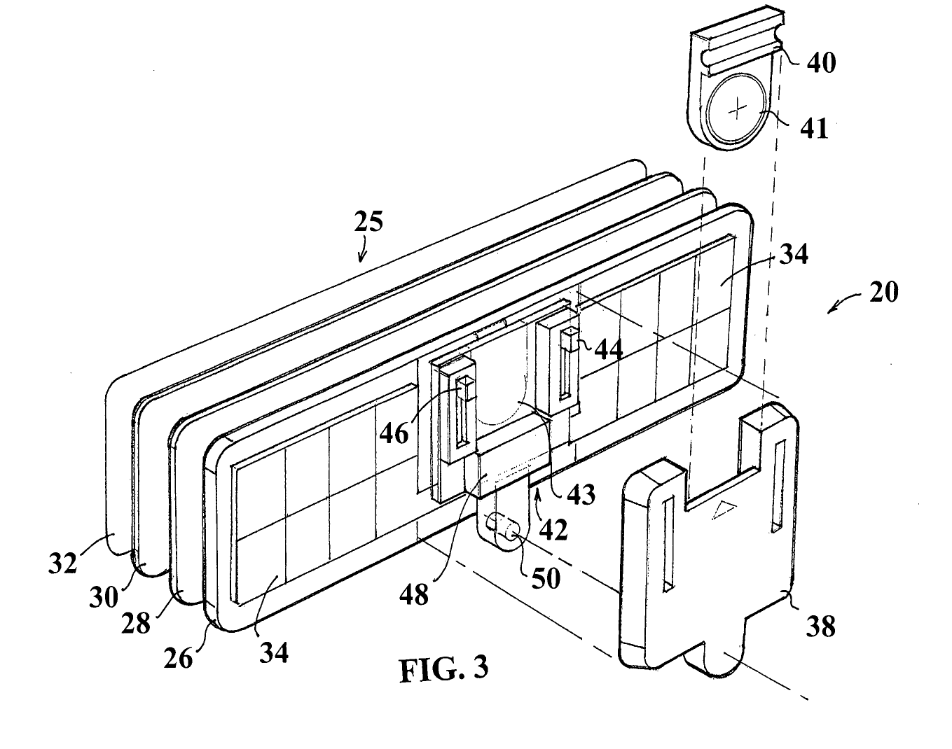

In one embodiment of this invention, at least one solar panel 34 is operatively connected, electrically and/or mechanically, to light film component 25, for example to provide backup power and/or recharge power to a battery operated or DC powered light film device 20. Solar panel 34 can be integrated with light film component 25, can be connected to light film component 25, such as to a back surface of housing 26 as shown in FIGS. 2 and 3, and/or can be an independent component tethered to light film component 25 via a wire or cable connection 36, such as shown in FIG. 12. Preferably but not necessarily, solar panel 34 is positioned, mounted or located with respect to any suitable structural component of a vehicle, for example to optimize absorption of solar power.

In certain embodiments of this invention, solar panel 34 can be structurally, mechanically and/or electrically connected to or integrated with housing 26 so that the solar collectors rotate and/or pivot with respect to each other and/or housing 26, for example to take advantage of any moving solar energy source. Any suitable servomotor control, structural and/or electrical connection can be used to accomplish any suitable relative movement. Single or multiple solar panels 34 can be used to accomplish different physical arrangements. When light film device 20 of this invention is used in a vehicle, the moveable solar panels 34 can be programmed to manually and/or automatically move to take advantage of a solar energy source and/or to at least partially conceal solar panel 34.

Light film device 20 may comprise battery module 40 positionable or mountable with respect to housing 26 of light film component 25. In one embodiment of this invention, battery module 40 is slidably positionable between module housing 38 and light film component housing 26, such as shown in FIGS. 2-4. Battery module 40 houses a suitable battery 41, such as a lithium cell, Ni-cad rechargeable button cell or standard AAA battery, which powers control module 42. Alternatively, control module 42 can be powered by DC power via power ports located within a vehicle, or even by another suitable voltage. In one embodiment of this invention, solar panel 34 is connected to battery 41 to recharge battery 41, as necessary.

As used throughout this specification and in the claims, the phrase control module is intended to be interchangeable with the phrase control device, the phrase controller, the phrase smart module and/or any other similar phrase that describes a programmed apparatus that controls one or more functions.

In one embodiment of this invention, control module 42 is in communication with a programmed controller, such as PC board 43, which can be mounted in a relatively fixed position with respect to light film device 20. Control module 42, PC board 43 and/or another suitable control element can control or can be programmed to control the operation and management of light film device 20. Preferably, as shown in FIG. 3, at least one of a plurality of components, such as a mode switch or sensor 44, a dim switch or sensor 46, a motion switch or sensor 48 and a light switch or sensor 50, each is operatively connected to and in responsive communication with PC board 43 and/or control module 42 to operate and/or manage an output of light film device 20. Any one or more of the switches or sensors can be hard wired to control module 42 and/or can communicate in a wireless mode with control module 42, such as by using Bluetooth™ technology or another suitable communication technology or protocol. At least one of the mentioned sensors, or another suitable sensor, can each emit a sensed signal. In one embodiment of this invention, control module 42 receives the sensed signal and emits an output signal as a function of the sensed signal, to operate EL element 28 or another suitable illuminated graphics panel.

In certain embodiments of this invention, light film device 20 may include any number of the components discussed in this specification, in addition to other suitable or interchangeable components known to those skilled in the art. Mode switch 44 can comprise a multiple position switch including an off position, a motion-on position, a motion-off position, and/or a constant operation position. Mode switch 44 can be used to select a position that operates light film device 20 within any necessary regulation or limited parameter. Dim switch or sensor 46 can include settings to adjust a lumens output level, as desired, for example to conform to any local ordinance, such as vehicle regulations within a particular jurisdiction. Motion sensor 48 can comprise any suitable sensor, such as a spring-type sensor, a rocker-type sensor, an accelerometer, a speedometer, a directional sensor and/or a position sensor. Light sensor 50 preferably communicates with control module 42 to provide appropriate power for proper operation of light film device 20, depending upon the time of day and/or weather conditions, such as darkness, cloudiness, rain, snow and/or fog.

Control module 42 can be interfaced with any suitable position identifying device, such as a Global Positioning System device. As used throughout this specification and in the claims, the phrase position identifying device is intended to be interchangeable with the phrase Global Positioning System device, and is also intended to be interchangeable with any other suitable mechanical and/or electrical device that identifies a position or location of light film device 20 according to this invention. In certain embodiments of this invention, control module 42 can be programmed to adjust any controllable parameter of light film device 20, such as a lumens output level. With such adjustment capabilities, light film device 20 of this invention can be used to manually or automatically identify a position and conform to local ordinances or regulations. Some local areas may require a minimum and/or a maximum lumens output level, which control module 42 can identify and deliver as an output signal to any controllable component of light film device 20. In addition, if any local area prohibits use of light film device 20 according to this invention, control module 42 can be programmed to automatically shut down or turn off light film device 20.

In certain embodiments of this invention, control module 42 can evaluate each sensed signal, process each sensed signal according to programmed steps, and then emit one or more output signals, each of which can include information, for example information to set a power rate at zero, partial power or full power.

In one embodiment of this invention, an internal timer switch can work or cooperate with motion switch 48 and activate at least one illumination switch to an on position, an off position or a partially powered position, after a determined time period has passed, for example a five (5) minute time period, based on a manual and/or an automatic mode determination and setting. Light film device 20 can also include a sound or noise sensor, a vibration sensor and/or a temperature sensor or switch. Additionally, various movement sensors can activate or trigger any one or more of programmed static and/or dynamic graphic animations.

As shown in FIG. 18, light film device 20 according to one embodiment of this invention comprises an independent or detachable control module 42, including mode switch or sensor 44, dim switch or sensor 46, motion switch or sensor 48 and light switch or sensor 50. A removable battery pack 60 and/or solar cell 34 can be connected via a connector, such as wire or cable 62 to light film component 25.

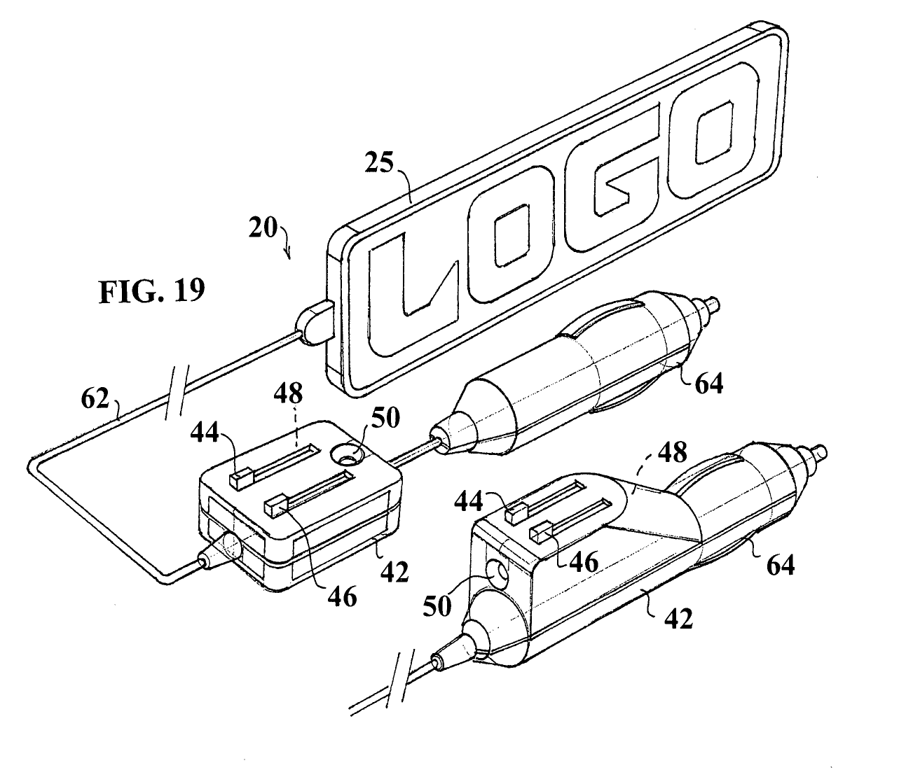

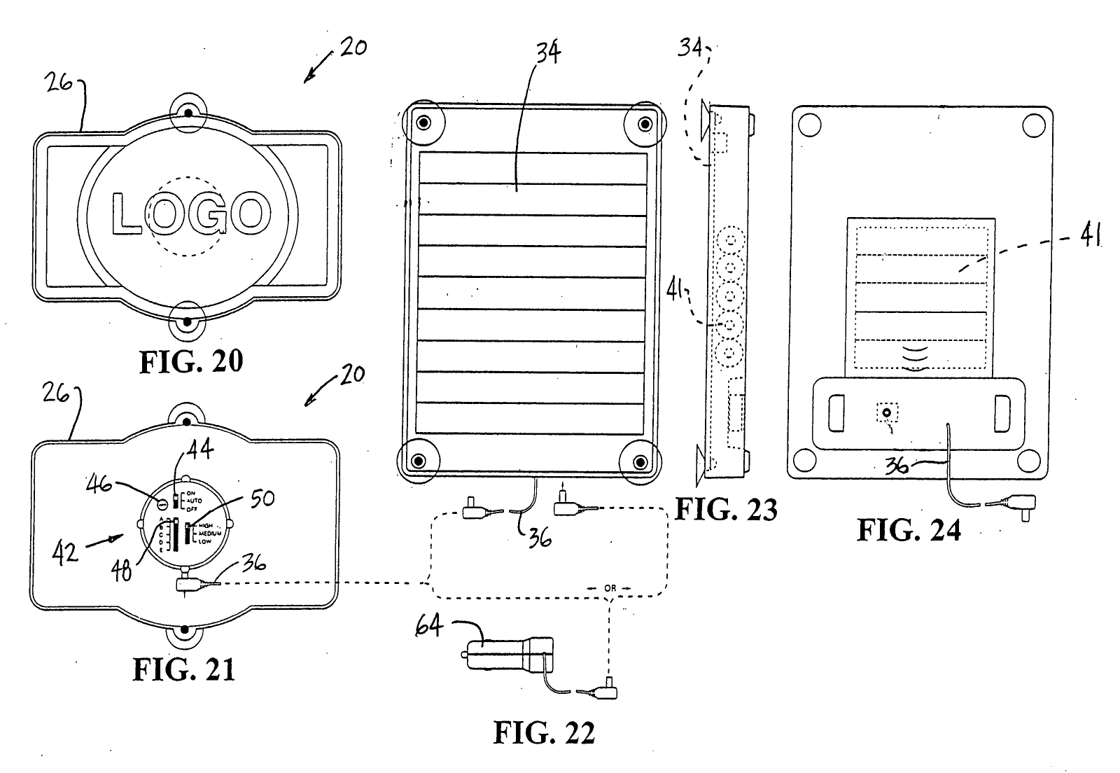

As shown in FIG. 19, light film device 20 according to preferred embodiments of this invention can comprise an independent or detachable control module 42, including mode switch or sensor 44, dim switch or sensor 46, motion switch or sensor 48 and/or light switch or sensor 50, connected to or integrated with plug housing 64, for example to deliver any suitable DC or other power. In one embodiment of this invention, control module 42 can be connected in-line with wire 62, as shown in FIG. 19. The sensors and/or switches of this invention can be used to prolong battery life.

Light film device 20, according to this invention, can produce illuminated graphics, such as those that operate and function in a parameter controlled environment. An illuminated graphics panel can function within parameters defined by control module 42. EL element 28 can be an EL lighted graphics panel that functions within specific parameters, such as those defined by local ordinances or rules, by using different types of sensors and/or switches to feed input information to control module 42, which can be programmed to operate and/or manage a particular environment.

Light film device 20 of this invention can provide illuminated graphics, particularly those which operate in a user-friendly parameter controlled environment. Parameters necessary for a specific controlled environment can be met by suitably programming control module 42 to automatically, with or without a manual input, operate and/or manage the controlled environment.

Light film device 20 can be constructed to achieve specifically desired illuminated graphics in an user-friendly manner, the extent to which can be a function of the programming of control module 42. In certain embodiments of this invention, light film device 20 requires relatively little user input and can be used to achieve the display of critical information, such as safety and hazzard information, as well as non-critical information, such as identifying membership in an organization or providing a graphic message. As an example of an non-critical function, housing 26 can be mounted in a rear window of a vehicle and a soccer ball can graphically move from left to right when the vehicle makes a left hand turn, or from right to left when the vehicle makes a right hand turn. Other similar non-critical messages can be communicated with light film device 20 of this invention.

Control module 42 and/or EL element 28 can be powered using a solar power cell alone or in combination with a battery power source. The solar power source can be used to automatically and/or manually recharge the battery power source. The solar power source can be part of or separate from housing 26. If separated from housing 26, the solar power source can be positioned at a different location, for example in a vehicle to optimize collection of solar rays.

Dim switch or sensor 46 can be used to automatically adjust a lumens output level in order to conform to any particular local regulations. Control module 42 can either calculate a position of light film device 20 and match the position with a stored library of lumens output level settings, for example to comply with a local ordinance, or can accommodate a manual input entry such as a zip code, to match in the stored or programmed library of values.

Light switch or sensor 50 can be used to detect the level of darkness in any particular environment and either automatically power light film device 20 or send a signal that alerts the user to power on light film device 20. Light switch or sensor 50 can be used in combination with dim switch or sensor 46 to adjust the lumens output level of light film device 20, as a function of the detected environmental conditions.

A timer can also be used in combination with motion switch or sensor 48, for example to switch on or off light film device 20, based on a particular mode setting. For example, control module 42 can be programmed to shut down power or go into a standby mode within a certain amount of time after a motion of a vehicle is no longer detected.

Any one or more of the sensors or switches of this invention can be used to send a signal to control module 42 that processes the one or more signals into a particular output signal that displays a particular graphic on EL element 28. For example, any sound, motion, temperature difference or other similar physical parameter can be processed through control module 42, to result in a graphic illustration. For example, stepping on an accelerator can result in a graphical display of a dynamic exhaust flame.

Any suitable integrated circuit board, either with or without one or more integrated circuit chips can be used in combination with or in addition to control module 42 to accomplish different programming capabilities for any input and/or output device.

Adhesion layer 32 can be of any suitable adhesive, either clear or colored, which is suitable to mount housing 26 and the associated elements with respect to a window or other suitable structure. EL element 28 can have any white or non-white color and may also comprise a back light theme graphics panel. EL element 28 may include multiple colored EL panels.

Housing 26 can be assembled in any suitable manner and can be mounted with respect to any suitable surface, including a vehicle surface.

Control module 42 may be locally mounted to housing 26 or can also be at a remote location, with wire or wireless communications, including Bluetooth™ technology or another suitable communication technology or protocol, to any device being controlled and/or sensed.

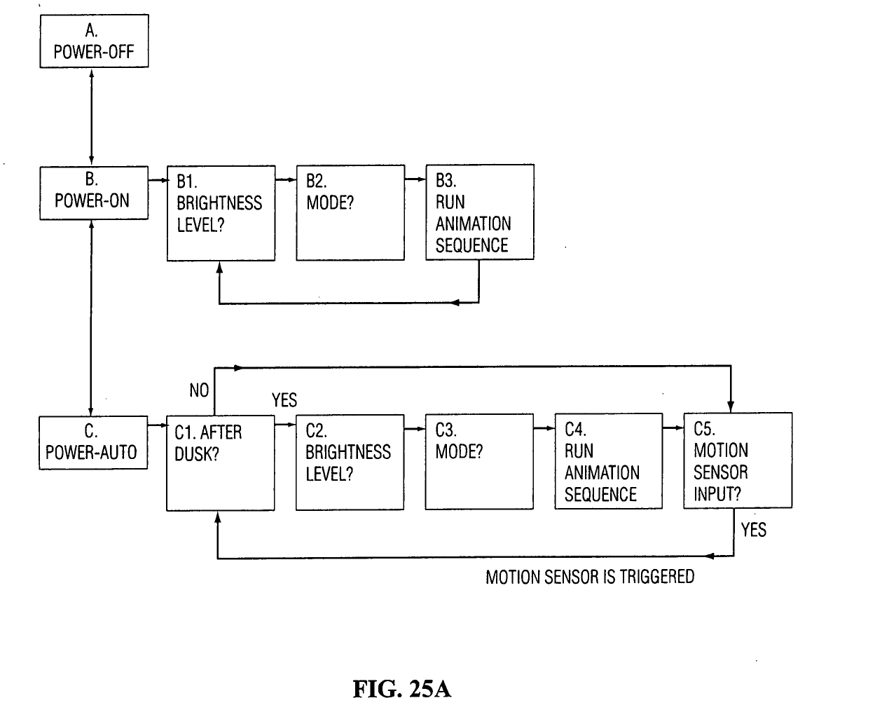

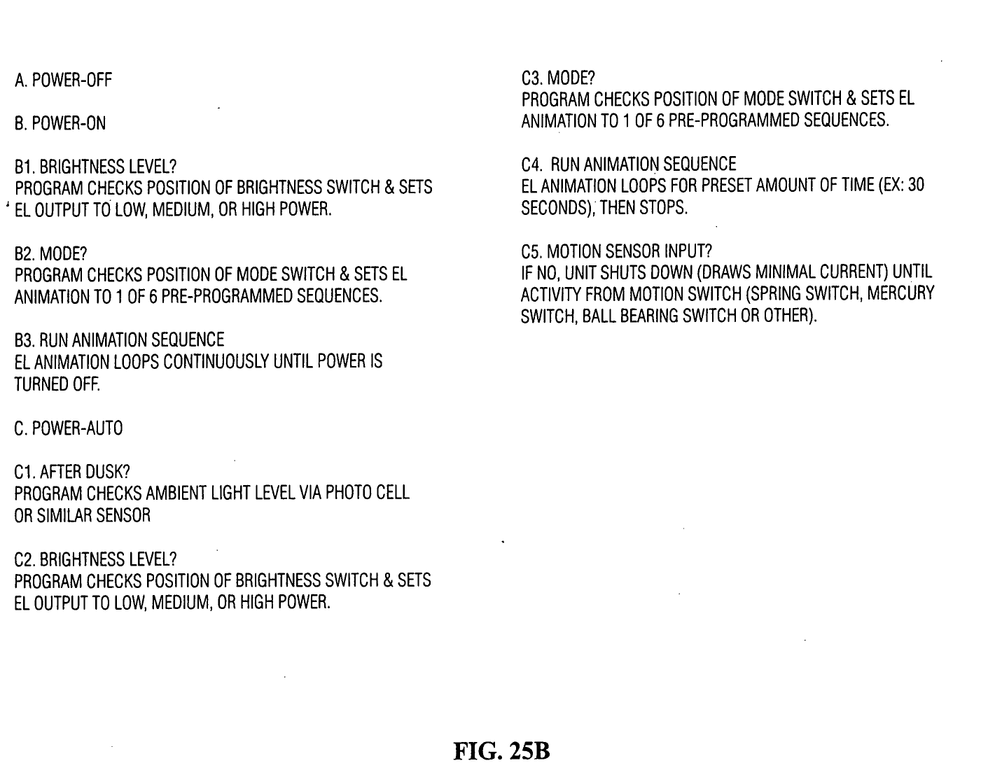

FIGS. 25-29 each shows a different flow chart of programmed steps for accomplishing different control modes, according to this invention. As shown in FIG. 25, EL element 28 can be activated in response to a signal received from motion switch or sensor 48. In the power-on setting, the program can check the brightness level, as set manually or automatically, for example to a level of low, medium or high power. In the power-on setting, the program then checks a position of mode switch or sensor 44. If the conditions are met, then EL element 28 displays graphics until the power is turned off.

As shown in FIG. 25, in the power-auto position, for light control, the program checks the signal received by light switch or sensor 50 and depending upon the position of mode switch or sensor 44, can run the graphics display either for a timed period or until activity is detected from motion switch or sensor 48.

According to the control shown in FIG. 25, light switch or sensor 50 can automatically shut down power when an ambient light level is greater than the light level of EL element 28, for example to conserve power. The user can select one or more animation sequences programmed for delivery to EL element 28, for example by using a slide switch, such as shown in FIG. 21. FIG. 21 also shows a manual switch for selecting one of a plurality of preset levels, shown as low, medium and high, for the lumens output level.

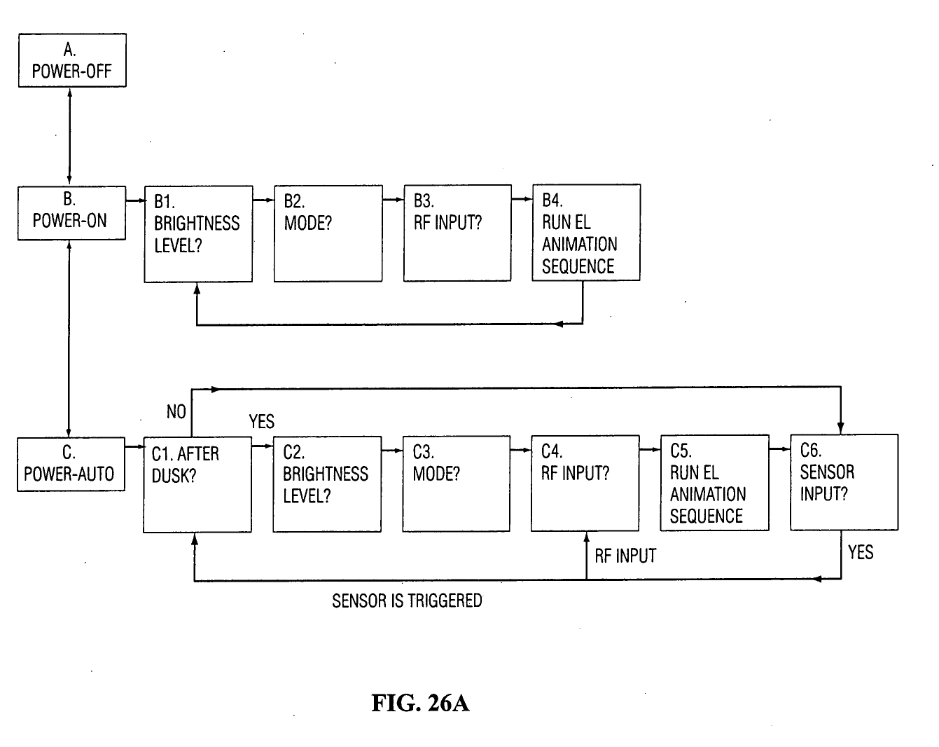

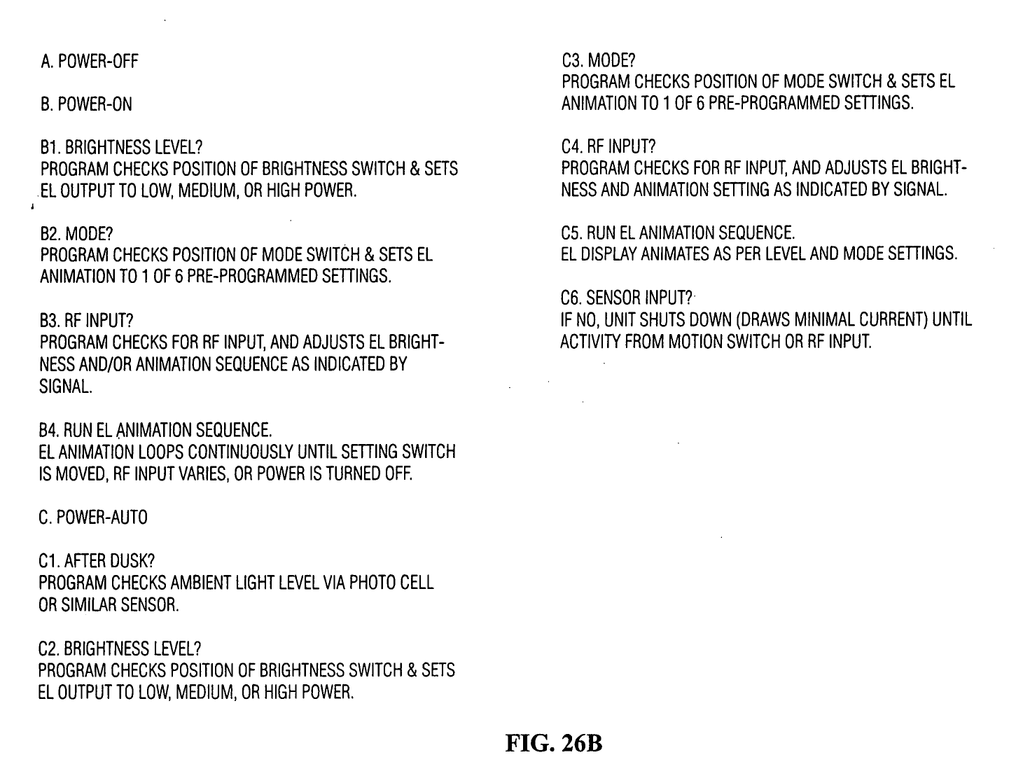

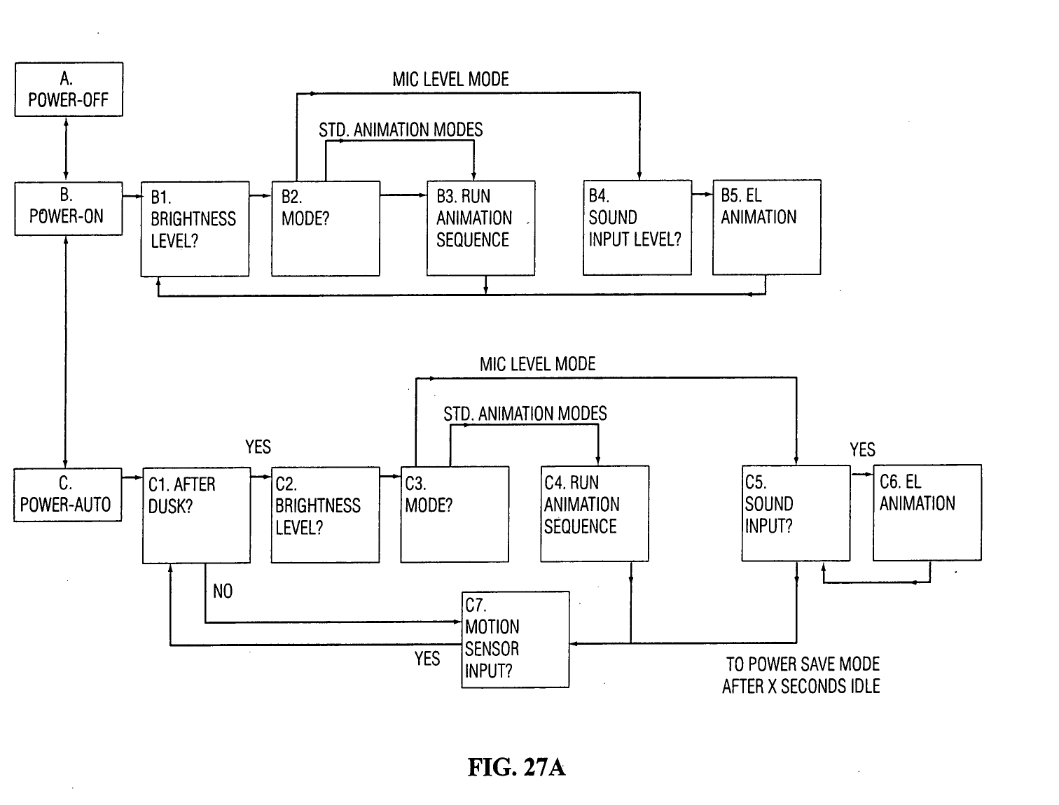

FIG. 26 shows another control scheme which includes a check for a wireless communication, such as a radio frequency (RF) signal. In addition to the program steps shown in FIG. 26, EL element 28 can be activated by a RF signal or by another informational signal, such as from a GPS satellite or a civil communications tower. In one embodiment of this invention, any lumens output level previously set can be overridden and/or replaced through another communication source, such as another RF input, or another GPS satellite input, or another suitable input signal. For example, an oncoming emergency vehicle can emit a signal that overrides and/or replaces the control function in order to display a warning signal to the driver or another nearby motorist.

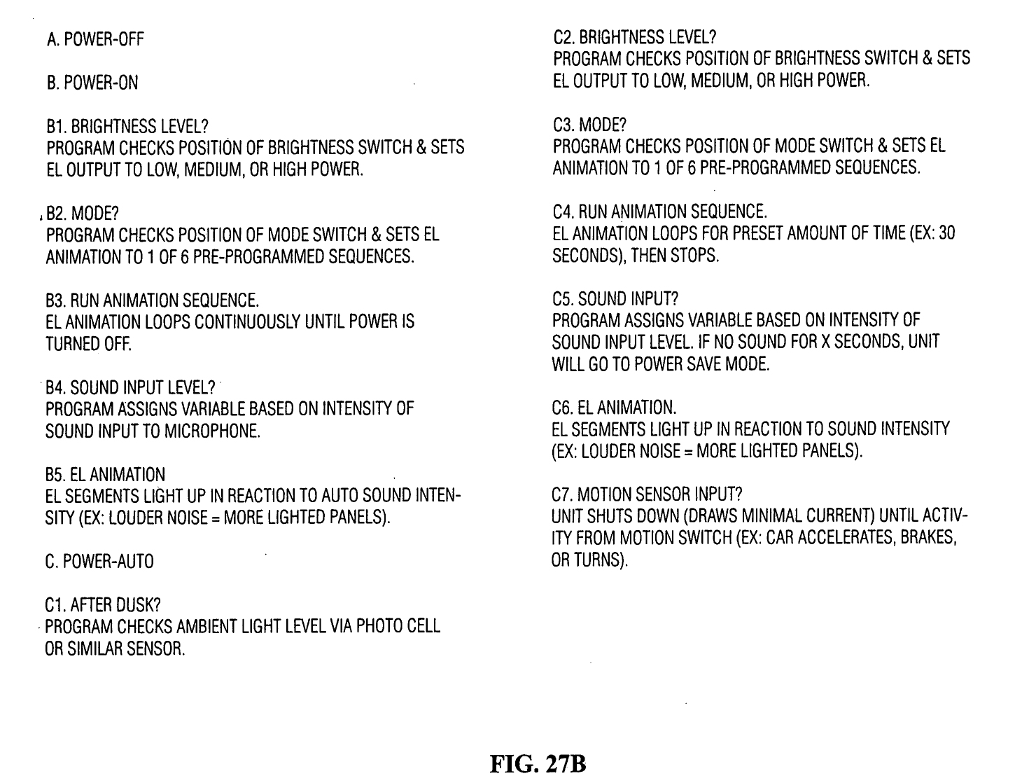

FIG. 27 shows another control scheme according to a different embodiment of this invention, wherein a noise level sensor, such as a microphone can be used to control the output at EL element 28. A user can select different animation sequences or graphical displays, for example as a function of either a mode from the microphone or a level of output from the microphone.

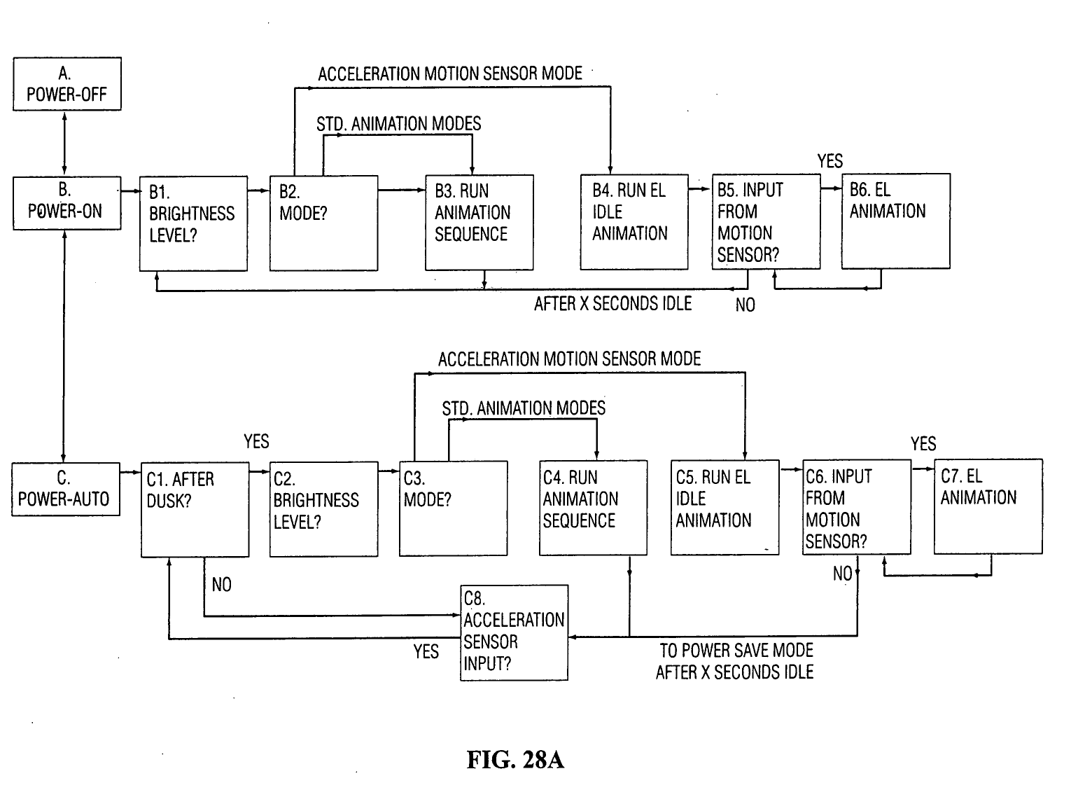

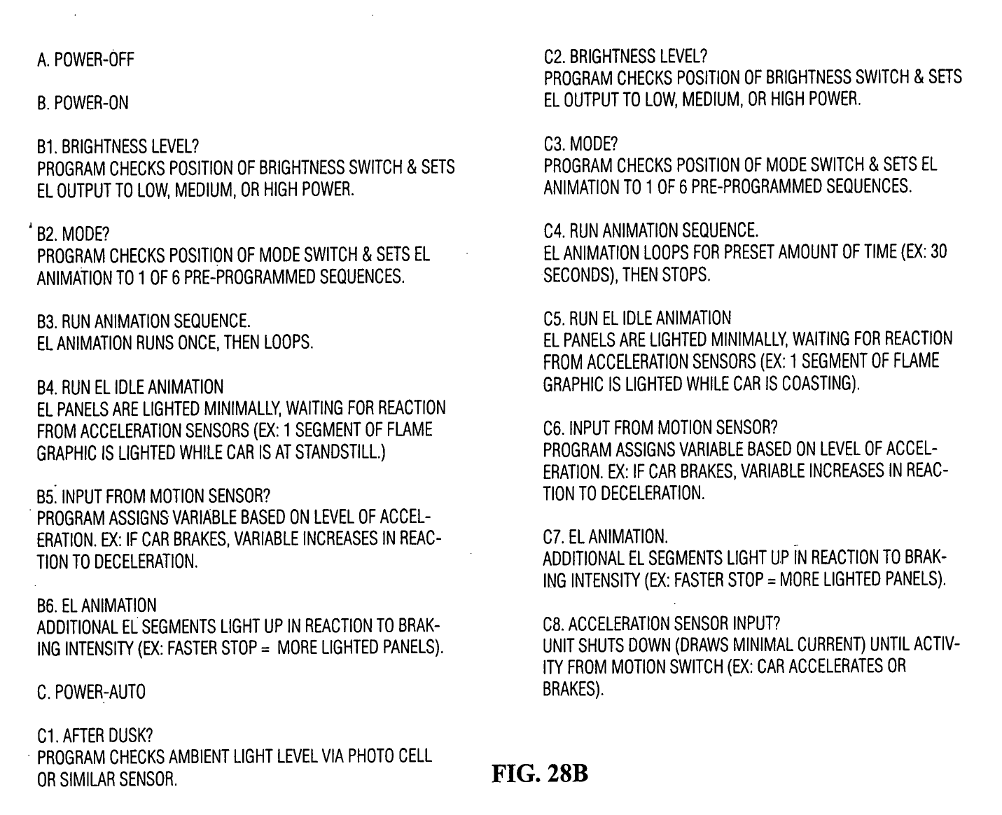

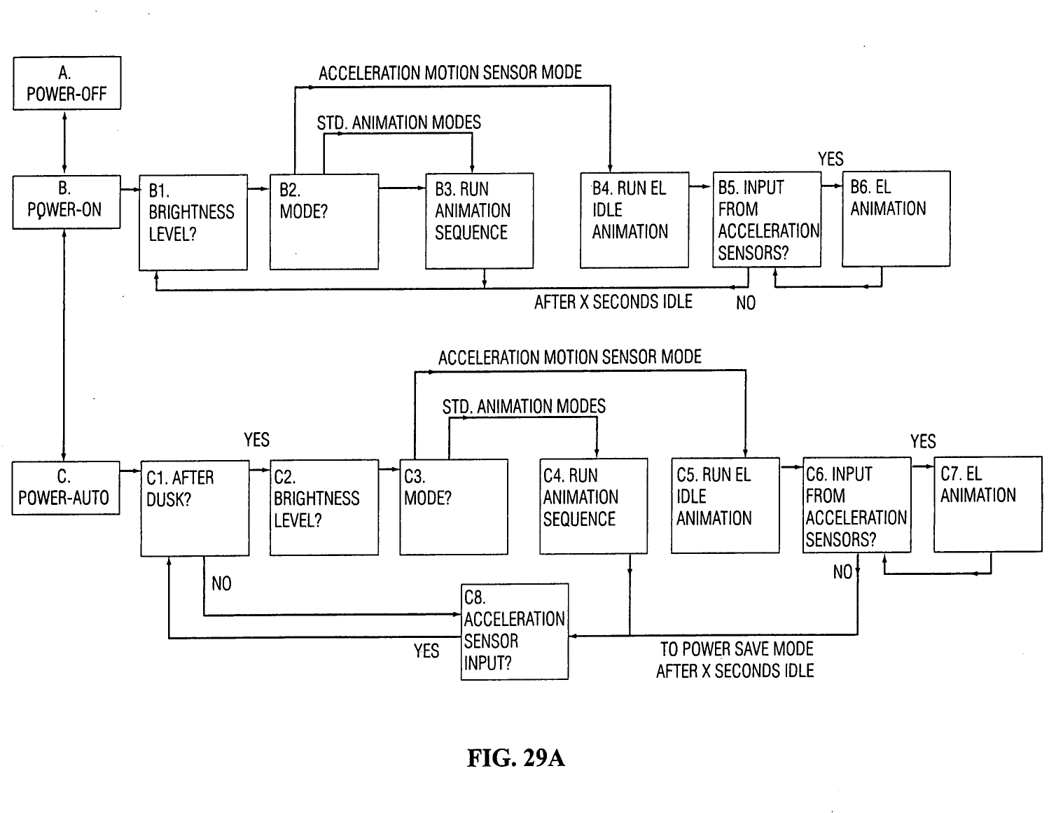

FIG. 28 shows a control scheme according to another embodiment of this invention, wherein an accelerometer is used to control the animation sequence or graphical display, for example as a function of a switch setting or a signal.

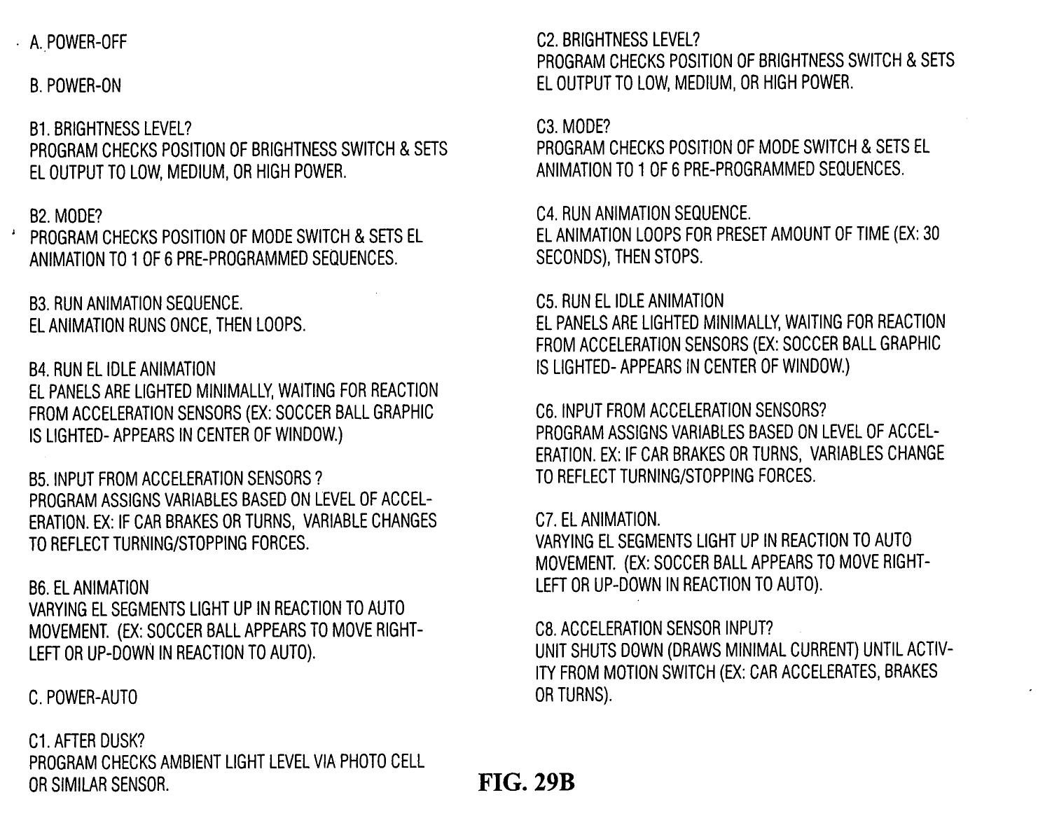

FIG. 29 shows a flow chart for a control scheme according to another embodiment of this invention, wherein a dual-acceleration sensor is used to deliver the input signal to control module 42. The dual-acceleration sensor can be used to sense breaking, turning and/or accelerating and thus deliver one or more input signals to control module 42, which can then emit one or more output signals to display a complex graphic, such as the left to right and/or up and down motion of a soccer ball, as previously discussed.

The different program steps identified in FIGS. 25-29 can be interchanged with each other. Additional computer steps can be used to convert any one or more sensed parameters into one or more output signals that can result in a graphic display, even a complex graphic display.

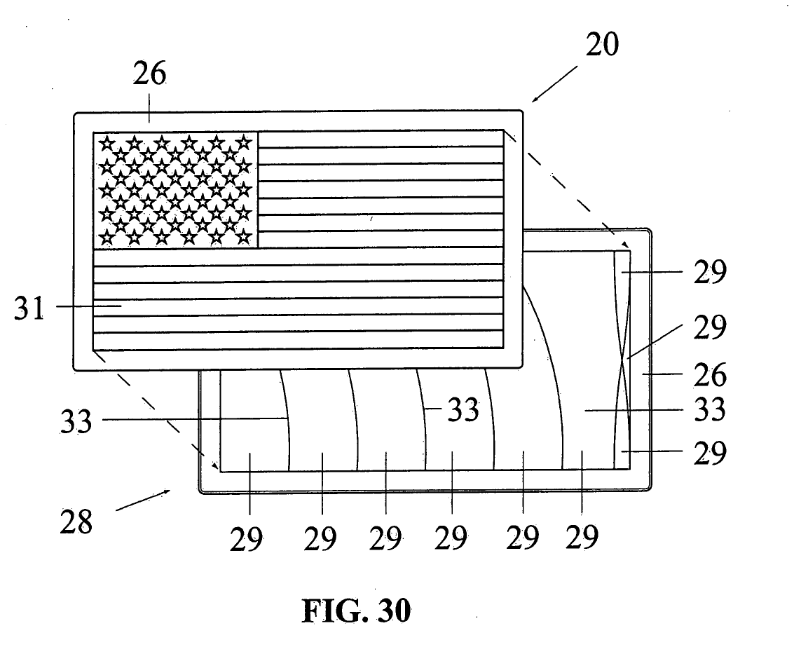

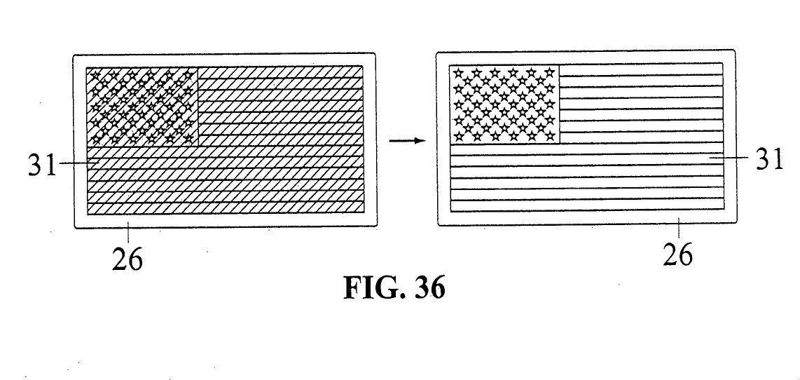

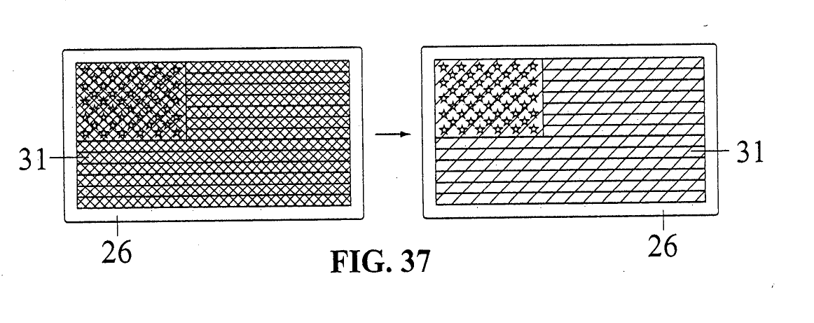

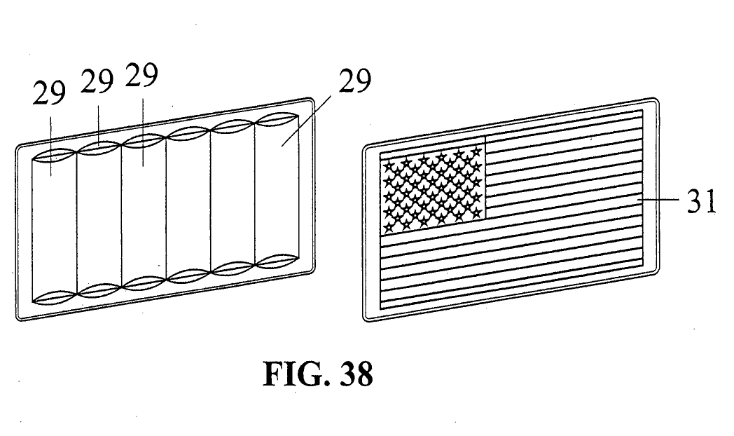

FIGS. 30-41 show other embodiments of light film device 20, according to this invention. Light film device 20 of this invention can be used to project, create or display a generally two-dimensional image and make the relatively planar image appear as a generally three-dimensional image, such as by independently controlling the brightness levels at each segment 29, to create a visual display that appears to have depth, in three dimensions. Light film device 20 of this invention can be controlled, particularly as a function of time, to produce or display illuminations that change over a given time period, for example to display a choreographed image that can be luminous and/or non-luminous.

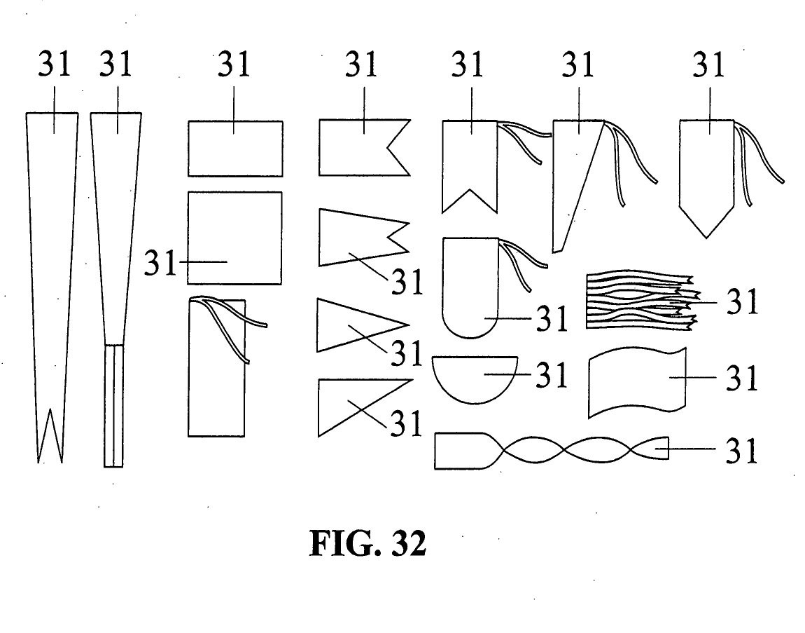

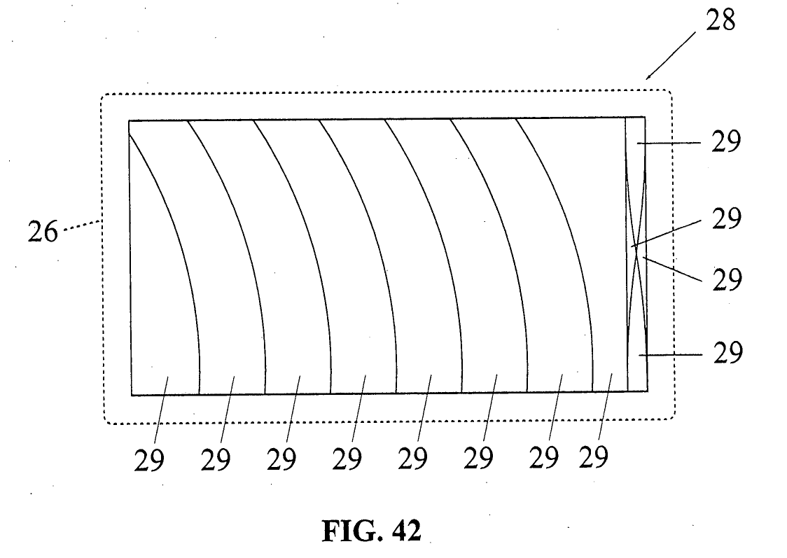

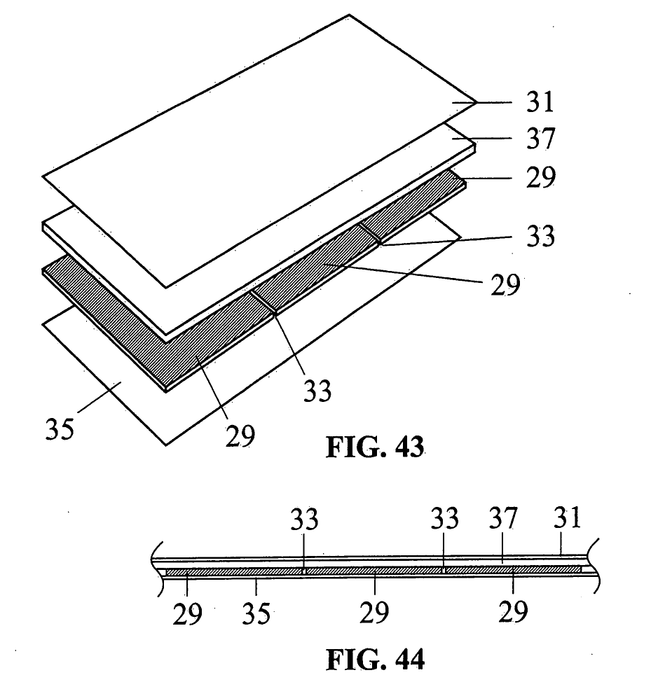

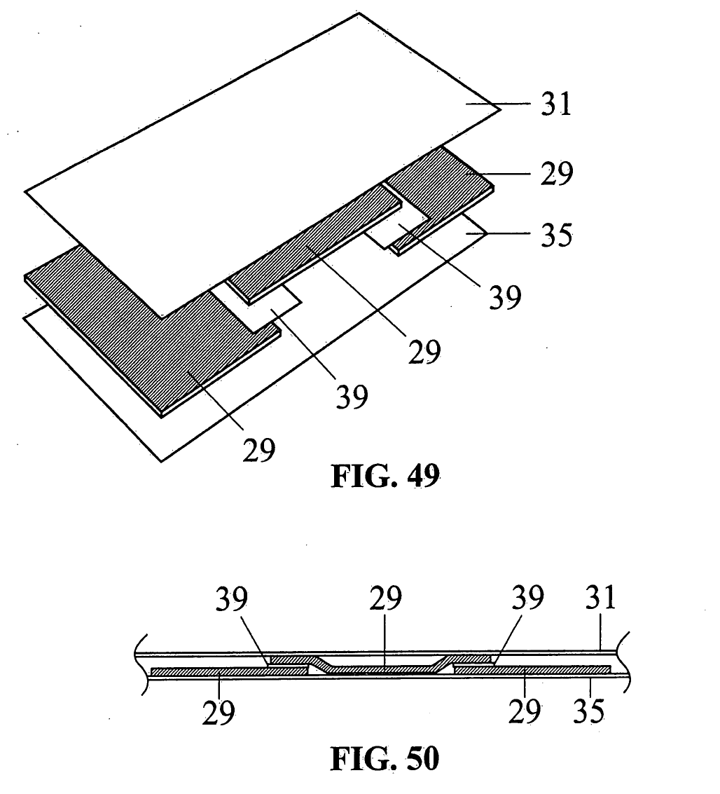

As shown in FIG. 30, the illuminated graphics panel comprises at least two segments 29 forming the overall EL element 28. As shown in FIG. 30, EL element 28 includes nine segments 29. As shown in FIG. 42, EL element includes twelve segments 29. Segments 29 can be positioned with respect to each other to form any suitable shape, including but not limited to the shapes shown in FIG. 32. Segments 29 can be positioned or mounted with respect to each other in a fixed manner or in a movable manner. For example, segment 29 can be supported by, mounted to, attached to or otherwise connected to substrate 35, such as shown in FIGS. 43-50. More segments 29, such as in a particular given area, can result in a better dynamic presentation and/or a smoother or fluidic visual presentation, particularly as segments 29 are operated over a given time period.

Because each of the plurality of segments 29 that form EL element 28 can be independently powered, such as at different illuminations or levels of luminosity, the image produced can appear as though it is moving. Each EL element 28 and/or segment 29 can be controlled and/or powered to produce either a luminous or a non-luminous display. Each segment 29 provides a source of light, a glow of which can be measured in lumens or can have a particular magnitude of a luminous flux. Segments 29 and/or EL element 28 may or may not be considered a light. The silhouette shapes of FIG. 32 show examples of different possible shapes of banners or flags. However, segments 29 can be sized, shaped and/or arranged to form any other suitable shape or design of EL element 28.

Controller or control module 42 can be programmed to manage the power that is delivered from a suitable power supply, such as battery 41 shown in FIG. 3, to each of segments 29, in any suitable programmed or selected manner. For example, control module 42 can result in each segment 29 being powered on and thus continuously illuminated, powered off and thus continuously not illuminated, or powered to an intermediate level that is constantly or intermittently varied. The control of the lighting of this invention can, for EL element 28, result in a completely lit mode, a completely unlit mode or a continuously varied or constant dimmed or brightened mode. Control module 42 can be programmed to and/or two or more segments 29 can be arranged or configured so that a same power input is simultaneously delivered to two or more segments 29. Thus, it is possible for two or more segments 29 to be powered by the same power input.

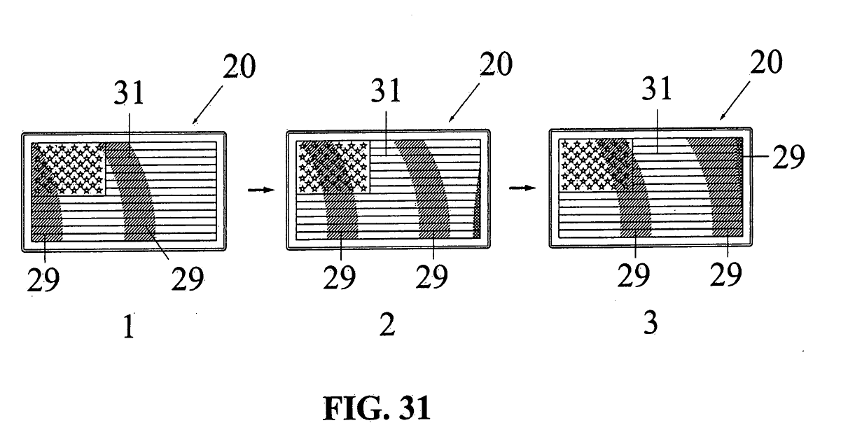

FIG. 31 shows a series of only one, the same, EL element 28 operating during a time period. As shown from left to right in FIG. 31, at position 1, each segment 29 is independently powered to a predetermined power level. As time progresses, moving from position 1 to position 2, and then to position 3, it appears that there is a moving or dynamic image, such as a waving flag. Segment 29 located at the right edge portion in each position of FIG. 31, can be powered on, powered off, or powered to an intermediate level, for example to produce a waving effect or another suitable choreographed effect, such as shown between positions 1, 2 and 3, at the right edge of the flag image.

Independently powering each edge section, such as shown in FIG. 42 by the four rightmost segments 29, can create an edge ripple effect. Programming segments 29 at the edge section, or the edge ripple, for example can make the flag image appear as though wind is affecting the flag. The edge ripple can be accomplished at any suitable position, including but not limited to other peripheral edge or edge portion, of EL element 28.

Each segment 29 can have an independent power terminal or another power connector positioned, connected and/or structured so that it delivers or supplies power from a power supply to each independent segment 29.

Control module 42 can be programmed in any suitable manner, such as to independently deliver and/or vary a power level delivered to each segment 29. Control module 42 can receive any of the sensed signals mentioned in this specification, to operate and/or control the power level delivered to each segment 29, instantaneously, intermittently, continuously and/or constantly over any given time period.

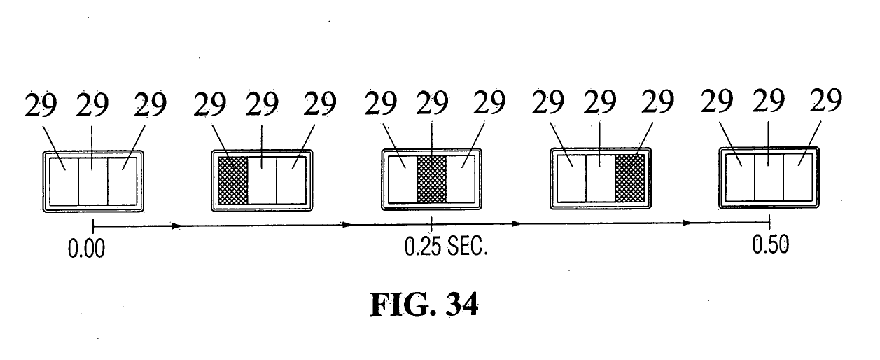

FIG. 34 shows one embodiment of individual segment 29 being powered on or powered off, over a time period of 0.5 seconds. FIG. 34 shows each segment 29 operating in either an on mode or an off mode, at a given time.

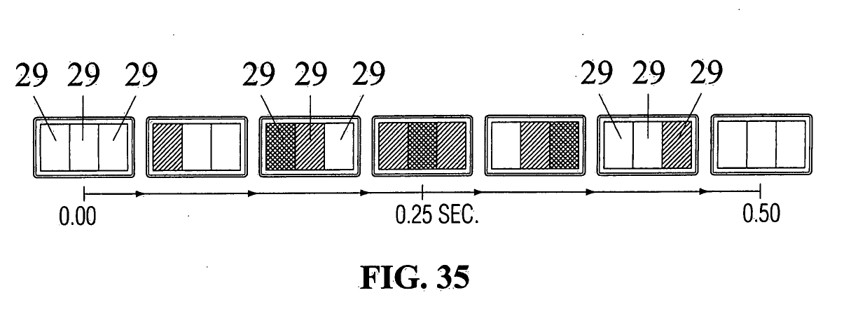

FIG. 35 shows a series of only one or the same EL element 28 operating with segments 29 in different modes, also over a time period of 0.5 seconds. Each individual segment 29 is independently powered to a completely on mode, a completely off mode, or to an intermediate power level mode. The intermediate level of power can range between 0 and 100% of the power. At a zero power level, segment 29 is in an off mode. At a 100% power level, segment 29 is in an on mode. An intermediate power level can vary anywhere between the off mode, at zero, and the on mode, at 100%. In certain embodiments of this invention, an intermediate power level can be used to provide or create a deeper or more defined three-dimensional moving or dynamic image, such as displayed on EL element 28 and/or graphics panel 31.

Any suitable electronic circuit or integrated circuit may comprise at least part of the controller or control module 42 to toggle between or switch each segment 29 to the on mode or to the off mode, and also to deliver a predetermined power level to each segment 29, over a time period to dim or brighten each segment 29 to a predetermined or programmed intensity or luminosity level. In certain embodiments according to this invention, control module 42 can have an electronic circuit, chip or other suitable software loadable device with programmed different power levels and different timing sequences, to deliver a desired display or illuminated choreography.

Control module 42 or any other suitable computer or programmed controller can be used to operate segments 29 to produce an overall dynamic display that is either continuous or intermittent. For example, as shown in FIG. 31, the different segments 29, which are also shown in FIG. 30, are operated by control module 42 to produce a waving effect. At position 1 in FIG. 31, the first and fourth segments 29, in a left to right direction, are powered. At position 2 in FIG. 31, the second and fifth segments 29 are powered. At position 3 in FIG. 31, the third and sixth segments 29 are powered. After position 3 is operated, the sequence returns to position 1 and loops through as many sequences as desired. The sequencing and/or varying the power level at independent segments 29 can be used to produce or provide a shadowing effect when EL element 28 is operated. Although FIG. 31 shows one particular sequencing, any other suitable sequencing, pattern and/or timing can be used to produce a different image.

Control module 42 can be programmed to continuously operate at least one segment 29 and/or to intermittently operate at least one segment 29. For example, an intermittent sequencing can be used to produce an interrupted rhythm, which can be different than a waving effect. For example, an interrupted rhythm can be used to produce a shimmering metals effect, a glimmering precious stones effect, a flame or fire effect and/or a flowing water effect. Flames can appear to flicker, particularly with an interrupted rhythm. Control module 42 can be programmed to loop an animation sequence pattern for a time period long enough that an observer does not consciously remember the pattern, which can be helpful in producing a realistic fire and/or water effect or image display.

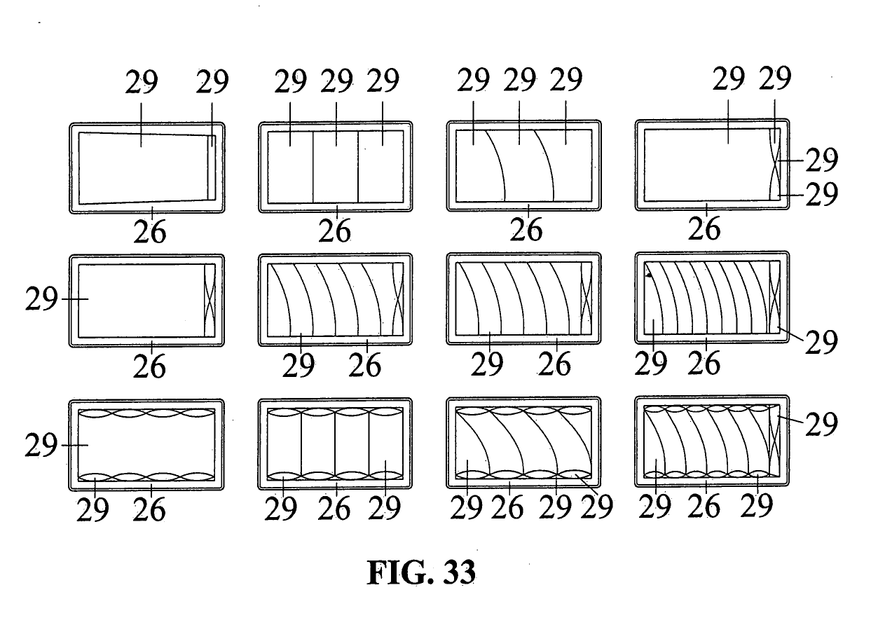

FIG. 33 shows different configurations, different shapes, different sizes and different numbers of segments 29 that form EL element 28. FIG. 33 is intended to show only some of many different possible shapes, styles, designs, configurations and/or sizes of segments 29 and/or EL elements 28 that can be accomplished according to this invention.

FIGS. 30 and 31 show outer layer or graphics panel 31 positioned coextensively with segments 29. Graphics panel 31 can act as an overlay to cover segments 29. Graphics panel 31 can have any suitable shape that corresponds to or does not correspond to the shape of segments 29, or to the overall shape formed when segments 29 combine to form EL element 28.

In certain embodiments according to this invention, adjacent segments 29 are electrically insulated from each other, such as in a non-conducting fashion. In some embodiments, the electrical insulation is accomplished by spacing adjacent segments 29 at a distance from each other, for example as shown in FIGS. 43 and 44, to prevent physical or electrically conducting contact. When positioning segments 29 with respect to each other, it is possible to form gap 33, such as shown in FIGS. 30, 43 and 44, where two adjacent segments 29 almost meet or contact each other.

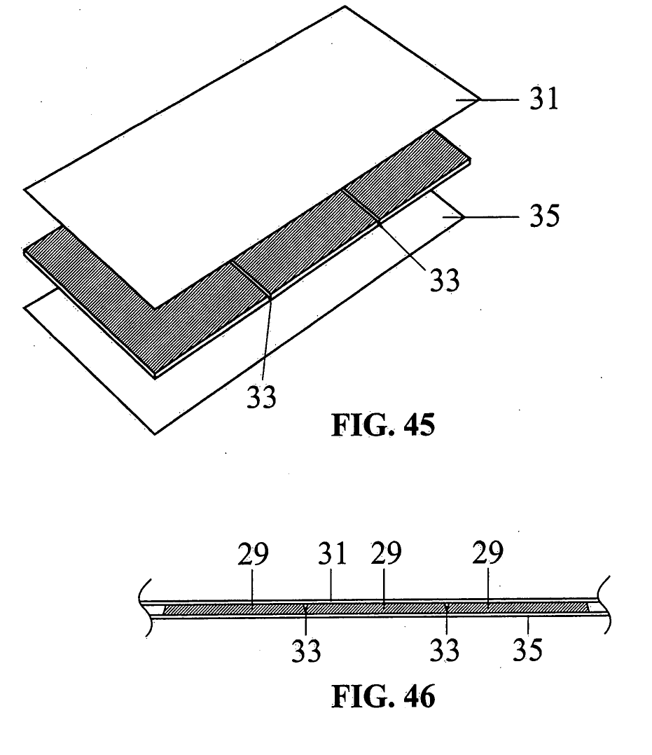

FIGS. 45 and 46 show another embodiment where adjacent segments 29 are spaced at a distance from each other. FIG. 46 shows gap 33 so relatively small that adjacent segments 29 visually appear to contact or touch each other. However, gap 33 remains large enough to prevent physical or electrically conducting contact between two adjacent segments 29. FIG. 46 shows each gap 33 formed as a V-shaped groove. However, any other suitable shape of gap 33 can be used to produce a visual appearance as though gap 33 does not exist.

In other embodiments according to this invention, particularly when gap 33 is at least somewhat visible, the visual appearance of gap 33 can be hidden, reduced or eliminated while still maintaining electrical isolation between adjacent segments 29. For example, substrate 35, such as shown in FIGS. 43-50, can be colored the same as or similar to at least one segment 29, to reduce or eliminate any visible lines created by gap 33.

In some embodiments of this invention, outer layer or graphics panel 31 can be constructed of a translucent material, or another suitable material that allows light to pass through the material. The translucent material can visually hide or reduce the appearance of any gap 33 over which graphics panel 31 is positioned. The translucent material can be an acetate material or any other suitable translucent or transparent material. In addition to or in lieu of graphics panel 31, certain embodiments of this invention may include diffuser 37, such as shown in FIGS. 43 and 44, which can be used to hide gap 33. Eliminating or reducing the visual appearance of gap 33 can result in a more realistic or more believable image or presentation.

In certain embodiments according to this invention, during manufacture or assembly, each segment 29 can be positioned or registered with respect to each other so that during the printing process a distance or thickness of gap 33 is maintained, reduced or minimized.

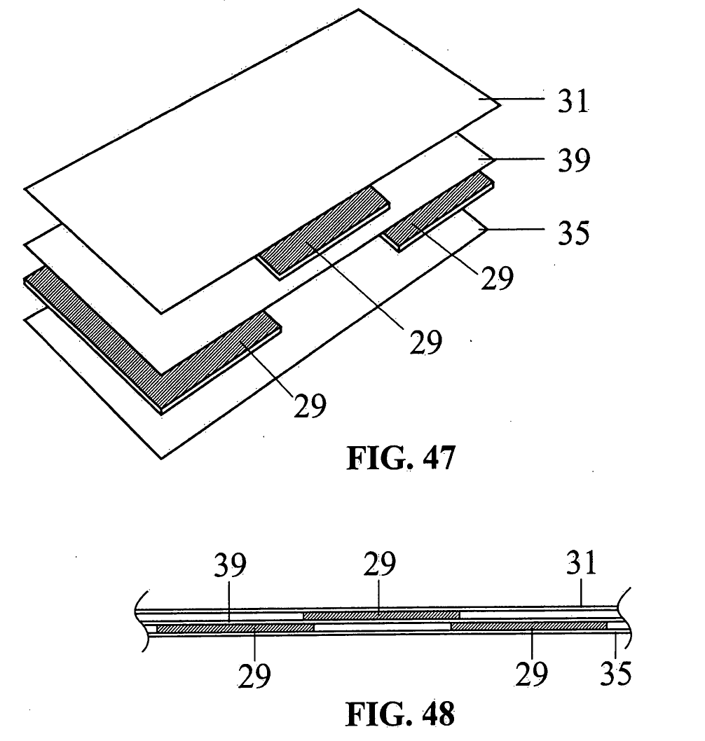

In other embodiments according to this invention, for example as shown in FIGS. 47-50, two adjacent segments 29 can overlap each other, such as at an edge portion or at peripheral portions, to eliminate the need for gap 33 or physical separation to maintain electrical insulation. For example, alternating segments 29, such as in a direction from left to right as shown in FIGS. 30, 42, 47 and 48, can be positioned on or within a first layer or thickness. The remaining segments 29, which may or may not alternate in order from left to right in FIGS. 30 and 42, can be positioned on or within a second layer or thickness. As shown in FIG. 48, for example, the second layer can overlay or be coextensive with the first layer, and edge portions of segments 29 can overlap each other, for example to eliminate otherwise visual gaps. Electrical insulation of adjacent segments 29 can be accomplished by applying or otherwise positioning a coating or layer of an electrical insulating material between any overlapping and/or contacting portions of segments 29. Two or more layers or thicknesses can be stacked or otherwise used to accomplish the electrical insulation aspects of this invention.

In another embodiment according to this invention, two or more adjacent segments 29 can be generally positioned within the same layer or thickness, such as shown in FIG. 50, insulator 39, with edge portions of adjacent segments 29 overlapping. In any overlapping area, an electrical insulating material and/or a coating can be positioned or applied to electrically insulate the adjacent segments 29 from each other.

In certain embodiments according to this invention, particularly where edge portions of segments 29 are coated or covered with an electrical insulator, it is possible to use a clear or translucent insulator material and/or color match or coordinate the insulator material with the color of the corresponding segment 29. Clear, translucent and/or color matching can be used to visually hide or decrease the appearance of the electrical insulator, for example when the corresponding segment 29 is in the off mode or at a relatively low or high power or intensity level. Without the color matching between segment 29 and any corresponding electrical insulator, the insulator material may be more visible than desired, even when viewed through graphics panel 31 and/or diffuser 37.

Segment 29 can be constructed from a phosphor material layer or coating. Any suitable phosphor material, such as those that may be commercially available as DUPONT® materials, can be used for segment 29. Any other suitable material known to those skilled in the art can be used to form a lightable segment 29. The material of segment 29 can be printed, sprayed, brushed or otherwise applied to form a desired or suitable layer or sheet of the material of segment 29.

The outer layer or graphics panel 31 and/or diffuser 37 can be positioned partially or completely over segments 29. It is also possible to position graphics panel 31 and/or diffuser 37 over only gap 31 or other overlap areas formed by segments 29.

Graphics panel 31 and/or diffuser 37 can have any suitable shape, size and/or design. In some embodiments according to this invention, segments 29 are positioned completely within an outer peripheral shape formed by all segments 29, which may be referred to as an inboard design or configuration. In other embodiments according to this invention, at least a portion of one or more segments 29 is positioned outside of the overall or outer peripheral shape formed by all segments 29, which is referred to as an outboard design or configuration.

With an inboard configuration, an image applied to graphics panel 31 can appear as the same image or a true image, whether or not EL element 28 is lit or otherwise powered. With an outboard design or configuration, the image can appear different between an operating mode and a completely off mode. For example, with an outboard configuration, a flag can appear to move between two different locations, boundaries or positions when EL element 28 is in the operating mode, but when in a completely off mode EL element 28 has two visually apparent images, each of a flag, which can be visually confusing. The inboard configuration can be used to create a visual appearance that the flag is moving but when EL element 28 is in the completely off mode, the flag will look like a normal single flag design, which would be the same image or the true image.

As used throughout this specification and in the claims, the term inboard is intended to relate to segments 29 positioned with respect to each other to form a boundary or a periphery about all segments 29, such as a boundary or periphery that has a true image. As used throughout this specification and in the claims, the term outboard is intended to relate to segments 29 positioned with respect to each other to form an overall boundary or periphery that does not form a true image. As used throughout this specification and in the claims, the term true image is intended to relate to the boundary or periphery of the true image having a true shape of the image or illumination projected by segments 29, either instantaneously or over time.

For example, FIG. 30 shows an inboard configuration because the flag is a true image and regardless of how segments 29 are powered or operated, the flag will always appear as a true image. With an inboard configuration of segments 29, such as shown in FIG. 30, the flag will look the same even when all segments 29 have no power or are in an off mode. Thus, for example, the true image of the flag will appear as the same flag, such as similar to a decal, when segments 29 are not powered.

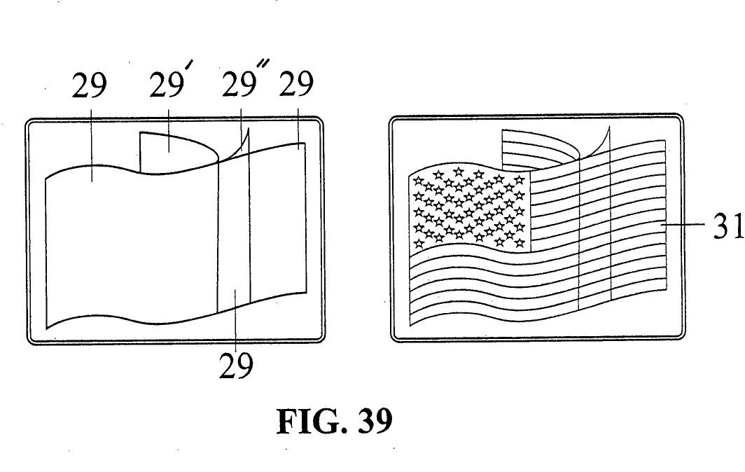

FIG. 39 shows one embodiment of an outboard configuration. As shown in the left diagram of FIG. 39, the three segments 29 form the image of a flag. However, segment 29′ can be operated with or without segment 29″, such as in a timed sequence, to give the flag an appearance that it is waving, even in three dimensions. However, with the outboard configuration, such as shown in FIG. 39, when all segments 29, 29′ and 29″ are powered off, the flag image is shown in the right diagram of FIG. 39. With all segments 29, 29′ and 29″ powered off, the flag appears as though it is not a true image because segments 29′ and 29″ can be seen or are visually apparent, along with all segments 29.

In certain embodiments with the inboard configuration, light film device 20 of this invention can appear as a decal, for example, in a window, in the completely off mode or appearing as a static, at-rest or steady image, and can also appear as a moving, dynamic, animated or in-motion image when EL element 28 is in the operating mode.

Any suitable frame or housing 26 can be used to structurally hold, attach or connect segments 29, EL element 28, graphics panel 31, control module 42 and/or any other element used in combination with the embodiments of this invention.

Housing 26 can be permanently or detachably secured with respect to any mounting surface, such as a glass window and/or a vehicle surface. In certain embodiments according to this invention, housing 26 is detachably secured with a hook and loop fastener, such as a Velcro™ fastener, and/or any suitable mechanical connector, including a track screwed to or otherwise secured to the mounting surface, with a lock plate that can be mounted within the track. The track can be designed, sized and configured so that the track and the plate is covered up when housing 26 is slid onto or otherwise connected to the track.

In other embodiments according to this invention, double sided tape or another suitable adhesive, such as glue or adhesion strips or other shapes, can be used to attach housing 26 with respect to the mounting surface.

In other embodiments according to this invention, housing 26 can be removably mounted using suction cups structurally attached to or with respect to housing 26. For example, tabs or other inserts can be mounted within any corresponding void to secure housing 26 with respect to a suction cup.

Plates, including wafer plates and die stamp thin metal plates, or injection molded plates or other shapes, can be used to mount or otherwise fasten housing 26 with respect to the mounting surface. Magnetic plates can also be used to mount housing 26 with respect to the mounting surface.

The controller management and power distribution to the independent segments 29, according to this invention, can be effectively used to project, display or otherwise create an appearance that segments 29, which are arranged in a generally planar or two-dimensional configuration, are a three-dimensional image or display enhanced with depth and definition.

In certain embodiments of this invention, light film device 20 can be operated by delivering power from a suitable power supply to the illuminated graphics panel 31 which overlays at least two segments 29. Control module 42 manages the power delivered to each of segments 29. During a given time period the illumination level or intensity of each segment can be either powered on, powered off, or powered to an intermediate level. With the independent control of each segment 29, it is possible to project or display a two-dimensional image as a three-dimensional image that appears to have significant depth.

EL element 28, segments 29, control module 42 and/or any other suitable element of this invention can communicate information to each other and/or between each other by using any suitable wire connection and/or wireless communication. For example, Bluetooth™ technology or any other suitable control technology, language, and/or protocol can be used to communicate information, such as commands or control signals.

In some embodiments according to this invention, segments 29 can be structurally connected to housing 26, and housing 26 can be mounted with respect to any structure, such as a window surface, a vehicle surface of a vehicle body or any other structural element.

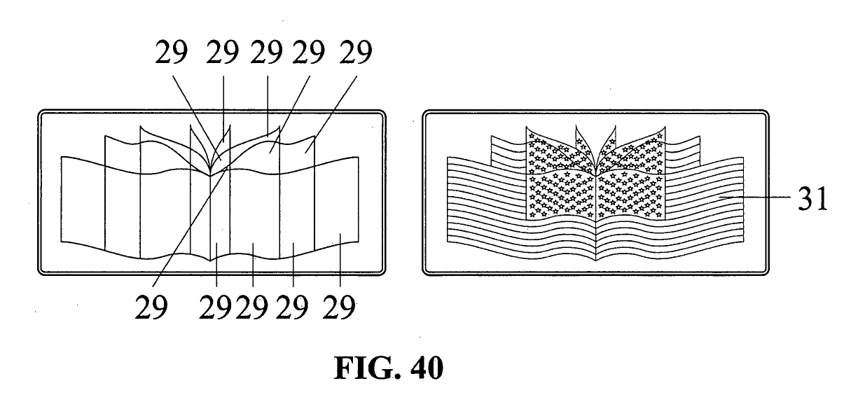

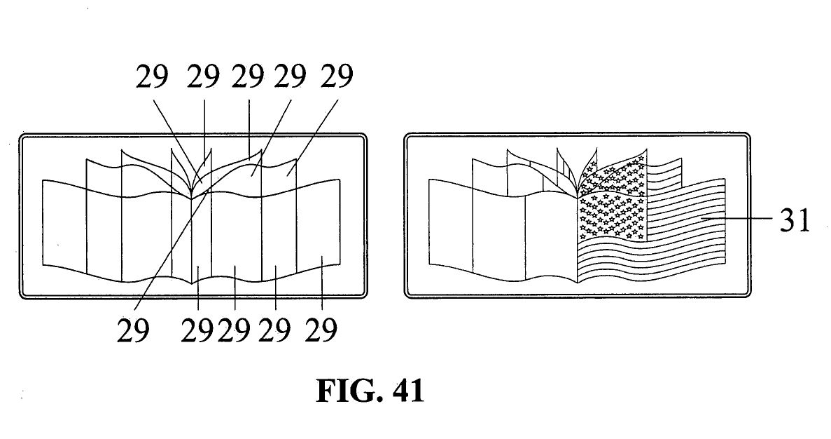

FIGS. 40 and 41 each shows EL element 28 having an outboard configuration, according to this invention. As shown in FIGS. 40 and 41, the flag image can move from a starting position to a finish position, with or without intermediate positions. In the operating mode of segments 29, as shown in FIGS. 40 and 41, the flag image appears to move between left and right. Any other shape or configuration can be used to display a different image. EL element 28 according to FIGS. 40 and/or 41 can produce an image with a more dramatic effect.

This invention is described in further detail in connection with the above embodiments or examples, which illustrate or simulate various aspects involved in the practice of this invention. It is to be understood that all changes that come within the spirit of this invention are desired to be protected and thus this invention is not to be construed as limited by any example or embodiment.

What is claimed is:

1. A light film apparatus comprising:
an illuminated graphics panel having at least two segments, a controller managing a power delivered from a power supply to each of the segments so that an illumination of each of the segments is one of powered on, powered off and powered to an intermediate level.

2. The light film apparatus according to claim 1, wherein each of the segments has an independent power terminal and the controller allows the power supply to deliver a predetermined power level to each independent power terminal.

3. The light film apparatus according to claim 1, wherein the controller communicates a power signal to each of the segments for independently controlling the illumination of each of the segments.

4. The light film apparatus according to claim 3, wherein over a time period the controller can independently vary the power supply to each of the segments.

5. The light film apparatus according to claim 1, wherein the segments are positioned adjacent to each other and form a gap between the segments to prevent electrical contact between the segments.

6. The light film apparatus according to claim 5, wherein a distance between the adjacent segments is sized so that the gap appears hidden.

7. The light film apparatus according to claim 5, wherein a diffusive layer is positioned over at least a portion of the segments and the gap.

8. The light film apparatus according to claim 1, wherein a first segment of the segments is within a first layer, a second segment of the segments is within a second layer, and the first layer overlays the second layer.

9. The light film apparatus according to claim 8, wherein at least a first portion of the first segment overlaps with at least a second portion of the second segment, and the first segment is electrically insulated from the second segment.

10. The light film apparatus according to claim 8, wherein the first layer and the second layer are stacked with respect to each other.

11. The light film apparatus according to claim 1, wherein at least a first portion of the first segment overlaps with at least a second portion of the second segment, and the first segment is electrically insulated from the second segment.

12. The light film apparatus according to claim 11, wherein at least one of the first portion and the second portion is coated with an electrical insulator.

13. The light film apparatus according to claim 1, wherein an electrical insulator covers at least a portion of at least one of the segments, and an insulator color of the electrical insulator matches a segment color of the segment to which the electrical insulator is applied.

14. The light film apparatus according to claim 1, further comprising an outer layer positioned coextensive with the segments.

15. The light film apparatus according to claim 14, wherein the outer layer is of a translucent material.

16. The light film apparatus according to claim 14, wherein the outer layer has a peripheral shape, and the segments are positioned completely within the peripheral shape to produce a true image when each of the segments is one of powered on, powered off and powered to an intermediate level.

17. The light film apparatus according to claim 1, wherein the outer layer has a peripheral shape, and the segments are positioned at least partially outside of the peripheral shape.

18. The light film apparatus according to claim 1, further comprising a frame housing the segments, and an outer layer positioned over the segments.

19. A method for operating a light film apparatus to display an appearance of a dynamic image, comprising:
delivering power from a power supply to an illuminated graphics panel having at least two segments;
managing the delivered power delivered to each of the segments; and
during a time period varying an illumination of each of the segments by at least one of powering on, powering off and powering to an intermediate level each of the segments.

20. The method according to claim 19, wherein varying the illumination of the segments creates a three-dimensional visual effect of the dynamic image from the relatively planar surfaces of the segments.

21. The method according to claim 19, wherein the illumination of a first segment of the segments is varied during the time period and the illumination of a second segment of the segments is pulsed between an on mode and an off mode during the time period.

22. The method according to claim 19, wherein an outer layer having a graphic display is positioned coextensive with the segments.

23. The method according to claim 22, wherein the graphic display is visible when the segments are in the off mode.

24. A method for operating a light film apparatus, comprising:
mounting the segments with respect to a surface of a vehicle;
delivering power from a power supply to an illuminated graphics display having at least two segments forming a flat panel; and
independently controlling power to each of the segments to create an appearance of a three-dimensional moving image from the flat panel.

25. The method according to claim 24, wherein the segments are mounted within a frame attached to the surface of the vehicle.

26. The method according to claim 24, wherein an illumination of a first segment of the segments is varied during a time period and of a second segment of the segments is pulsed between an on mode and an off mode during the time period.
